(19) United States
(12) Patent Application Publication
(10) Pub. No.: US 2026/0291751 A1
(43) Pub. Date: Sep. 24, 2026

(54) DYNAMIC WORKFLOW GENERATION WITH INTEGRATED SERVICE TASKS

(71) Applicant: Entrust Corporation, Shakopee, MN (US)

(72) Inventors: Andrew MacCuaig, Ottawa (CA); Noah Mank, Ottawa (CA); Yuming Ding, Ottawa (CA)

(21) Appl. No.: 19/573,556

(22) Filed: Mar. 20, 2026

Related U.S. Application Data
(60) Provisional application No. 63/774,945, filed on Mar. 20, 2025.

(51) Int. Cl. H04L 9/32; H04L 9/06

(52) U.S. Cl. CPC H04L 9/3247; H04L 9/0631

(57) ABSTRACT

Dynamic workflow generation with integrated service tasks is provided. In example aspects, one or more services are integrated with a workflow platform. For example, an application programming interface implemented by the one or more services may be integrated with the workflow platform. In examples, the integrated services may be configured to perform operations that the workflow platform is not configured to perform. A workflow including a plurality of tasks may be built using a workflow generation user interface. During execution of the workflow, one or more of the tasks may be performed, at least in part, by an integrated service. In examples, the workflow may be dynamically generated based on dependencies between task attributes. The dependencies may be determined based on a temporal order of the tasks and a set of relationships between task attributes.

### CROSS-REFERENCE TO RELATED APPLICATIONS

This application claims priority to U.S. Provisional Patent Application No. 63/774,945 filed Mar. 20, 2025, the disclosure of which is incorporated herein by reference in its entirety.

### BACKGROUND

In the field of digital security, particularly in the implementation of authentication and identity verification (IDV) workflows, various security procedures may be implemented, such as to protect secure resources. These security procedures may include a variety of security measures configured to mitigate potential vulnerabilities. For example, a security procedure can include a liveness detection operation to distinguish between a real person and a fake representation (e.g., a photo, video, or mask) to mitigate spoofing attacks.

Authentication and IDV systems are often susceptible to a range of security vulnerabilities including, but not limited to, phishing attacks, brute force attempts, and man-in-the-middle attacks. These vulnerabilities can compromise user data and system integrity. To address these varied considerations, conventional security procedure systems often specialize in a particular type of security measure. For example, a first service provider may focus on identity verification while another service provider may focus on risk assessment. As a result, entities that require multiple security measures must manually configure a security procedure that separately integrates with each of the services. The integration of disparate services is complex, generally requiring users to have coding expertise and technical knowledge to coordinate workflows across the plurality of services, as well as legal expertise to navigate regulatory and privacy standards across jurisdictions.

### SUMMARY

In accordance with aspects of the present disclosure, a dynamic workflow service is provided that allows for customization of authentication and signing tasks within identity verification (IDV) procedures. In example aspects, one or more services are integrated with a workflow platform. For example, the workflow platform may integrate an application programming interface implemented by the services. During execution of a workflow at the workflow platform, one or more tasks included in the workflow may be performed, at least in part, by an integrated service.

In a first aspect, a method for executing a workflow is provided. A request to obtain a digital signature as part of a workflow is received at an identity verification workflow platform. The identity verification platform includes an integrated document signature service configured to capture a first type of electronic signature and a second type of electronic signature. The workflow is executed. The workflow includes an identity verification task performed by the identity verification workflow platform and a signature capture task performed, at least in part, by the integrated document signature service.

In a second aspect, a system for executing a workflow is provided. The system includes one or more processors and one or more computer-readable storage devices storing data instructions. The data instructions, when executed by the one or more processors, cause the system to receive a request to obtain a digital signature as part of a workflow at an identity verification workflow platform and execute the workflow. The identity verification platform includes an integrated document signature service configured to capture a first type of electronic signature and a second type of electronic signature. The workflow includes an identity verification task performed by the identity verification workflow platform and a signature capture task performed, at least in part, by the integrated document signature service.

In a third aspect, a non-transitory computer-readable medium is provided. The computer-readable medium has stored thereon data instructions that, when executed by one or more processors, cause the one or more processors to receive a request to obtain a digital signature as part of a workflow at an identity verification workflow platform and execute the workflow. The identity verification platform includes an integrated document signature service configured to capture a first type of electronic signature and a second type of electronic signature. The workflow includes an identity verification task performed by the identity verification workflow platform and a signature capture task performed, at least in part, by the integrated document signature service.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an environment in which a workflow may be created and used, according to an embodiment.

FIG. 2 illustrates an alternative embodiment of an environment in which a workflow may be created and used.

FIG. 3 illustrates a workflow generation user interface for a workflow including a risk assessment task, according to an embodiment.

FIG. 4 illustrates a task configuration interface for editing a configuration of a risk assessment task, according to an embodiment.

FIG. 5 illustrates a task configuration interface for editing inputs of a risk assessment task, according to an embodiment.

FIG. 6 illustrates a message flow diagram for performing a risk assessment task, according to an embodiment.

FIG. 7 illustrates a workflow generation user interface for a workflow including a signature capture task and a signed document storage task, according to an embodiment.

FIG. 8 illustrates a task configuration interface for editing a configuration of a signature capture task, according to an embodiment.

FIG. 9 illustrates a task configuration interface for editing inputs of a signature capture task, according to an embodiment.

FIG. 10 illustrates a message flow diagram for performing a signature capture task and a signed document storage task, according to an embodiment.

FIG. 11 illustrates a workflow generation user interface for a workflow including a user creation task and an authenticator registration task, according to an embodiment.

FIG. 12 illustrates a task configuration interface for editing a configuration of a user creation task, according to an embodiment.

FIG. 13 illustrates a task configuration interface for editing inputs of a user creation task, according to an embodiment.

FIG. 14 illustrates a task configuration interface for editing a configuration of an authenticator registration task, according to an embodiment.

FIG. 15 illustrates a task configuration interface for editing inputs of an authenticator registration task, according to an embodiment.

FIG. 16 illustrates a message flow diagram for performing a user creation task and an authenticator registration task, according to an embodiment.

FIG. 17 illustrates another message flow diagram for performing an authenticator registration task, according to an embodiment.

FIG. 18 illustrates a workflow generation user interface for a workflow including a user authentication task, according to an embodiment.

FIG. 19 illustrates a task configuration interface for editing a configuration of a user authentication task, according to an embodiment.

FIG. 20 illustrates a task configuration interface for editing inputs of a user authentication task, according to an embodiment.

FIG. 21 illustrates a message flow diagram for performing a user authentication task, according to an embodiment.

FIG. 22 illustrates a workflow generation user interface for a diverging workflow, according to an embodiment.

FIG. 23 illustrates a task configuration interface for editing a configuration of a navigation task, according to an embodiment.

FIG. 24 illustrates a navigation screen for enrolling an authenticator, according to an embodiment.

FIG. 25 illustrates a flowchart of a method for executing a workflow, according to an embodiment.

FIG. 26 illustrates a first step of dynamic generation of a workflow, according to an embodiment.

FIG. 27 illustrates a second step of dynamic generation of a workflow, according to an embodiment.

FIG. 28 illustrates a third step of dynamic generation of a workflow, according to an embodiment.

FIG. 29 illustrates a fourth step of dynamic generation of a workflow, according to an embodiment.

FIG. 30 illustrates a fifth step of dynamic generation of a workflow, according to an embodiment.

FIG. 31 illustrates an invalid workflow, according to an embodiment.

FIG. 32 illustrates a set of relationships of task attributes, according to an embodiment.

FIG. 33 illustrates a flowchart of a method for generating a workflow, according to an embodiment.

FIG. 34 illustrates a block diagram of an embodiment of a computing device on which aspects of the present disclosure may be implemented.

### DETAILED DESCRIPTION

Customizing security procedures to meet the diverse needs of users and regulations poses significant challenges in the field of authentication and identity verification (IDV) workflows. Different applications or jurisdictions may require varying levels of security, which must be balanced with the need for ease of use and accessibility. The ability for entities to adjust security procedures allows entities to accommodate a wide range of user capabilities, risk profiles, and regulatory standards. However, the ability to effectively customize security protocols is often constrained by the limitations of existing systems, particularly when dealing with legacy infrastructure that may not be adaptable to modern, flexible security solutions. These legacy systems are often limited in scope as each additional security measure or workflow operation incorporated into a workflow increases complexity.

Embodiments of the present disclosure address these technical challenges and provide for implementation of security measures that are both robust and user-centric, allowing for dynamic and scalable security protocols without sacrificing usability.

In accordance with aspects of the present disclosure, dynamic and codeless logic handling is provided. Embodiments of the present disclosure can, for example, deploy a robust attribute management framework that organizes and processes metadata, data linkages, and logic dependencies across tasks within a workflow process instance. The workflow platform leverages this framework to infer coding logic from a drag-and-drop user interface. For example, a temporal order of workflow tasks can be determined based on an arrangement of graphical representations of those workflow tasks. This approach allows for the automatic population of fields between tasks in a workflow by dynamically associating those fields with references or links to fields from preceding tasks (e.g., based on the temporal order). For example, user data collected in an onboarding identity verification (IDV) task may be automatically repurposed to populate a name field in a subsequent signature task, reducing data entry. Artificial intelligence (AI) mechanisms can enhance usability by providing suggested references, such as autocomplete functionality, to streamline configuration further.

A drag-and-drop architecture is realized through a visual workflow generation interface that enables users to construct workflows by arranging modular task elements on a graphical canvas. Each task element represents a discrete operation, such as biometric capture, risk assessment, or digital signature collection, and is defined by a task schema that includes, for example, a task type identifier, a set of configurable attributes (e.g., input fields, output mappings, timeout settings), and a reference to an execution handler, which may correspond to an internal service or an external API endpoint. As users drag task elements onto the canvas, the identity verification platform instantiates task objects with default metadata and uses their spatial arrangement to infer execution order. For example, vertical positioning may determine temporal sequencing, while connectors between tasks define explicit dependencies.

The identity verification platform maintains an attribute dependency graph that is dynamically updated as users link outputs from one task to inputs of another. This graph supports automatic validation of input satisfaction, propagation of attribute values across tasks, and detection of invalid configurations such as circular dependencies or missing inputs. Each task's configuration panel is rendered contextually, allowing users to modify parameters and define attribute mappings through a schema-driven form renderer that ensures only valid options are presented.

At runtime, the workflow is compiled into an executable process model comprising a directed acyclic graph (DAG) of task nodes, a task execution plan with resolved service bindings, and a runtime context object that tracks attribute values and task states. This architecture, which may be implemented using web technologies such as React and SVG or Canvas APIs, separates visual design from execution logic, enabling non-technical users to author complex, compliant workflows while ensuring correctness, extensibility, and seamless integration with third-party services.

In a first aspect, the disclosed drag-and-drop architectural approach democratizes workflow creation by enabling legal, compliance, and business stakeholders who may lack programming expertise to design and deploy compliant, high-assurance workflows tailored to specific use cases or jurisdictions.

In a second aspect, the disclosed drag-and-drop architectural approach reduces integration complexity by abstracting service-specific API details behind standardized task interfaces, allowing users to incorporate advanced capabilities (e.g., QES signing or biometric verification) through simple visual configuration.

In a third aspect, the disclosed drag-and-drop architectural approach accelerates iteration and deployment by enabling real-time validation of workflow logic and compliance constraints during design, reducing the need for post-deployment debugging or legal review.

In a fourth aspect, the disclosed drag-and-drop architectural approach enhances maintainability by centralizing logic in a declarative, visual format, reducing the risk of configuration drift and simplifying updates when regulatory requirements or service capabilities change.

Accordingly, determining workflow logic based on an arrangement of graphical representations of workflow tasks empowers users without technical or regulatory expertise to design and manage workflows intuitively. Within this system, attribute dependencies and relationships between workflow tasks can be dynamically modified by users as required. As new tasks are added to the workflow, the workflow platform automatically integrates their associated attributes into the options available for modification.

Digital signature workflows often must comply with jurisdiction-specific regulations that impose technical requirements on the relationship between identity verification and signature capture processes. For example, certain regulations require that a qualified electronic signature (QES) be preceded by identity verification meeting specific assurance levels, or that signature delegation be prohibited for particular document types. In conventional workflow systems, ensuring compliance requires either manual review by legal experts of each workflow configuration, which is time-consuming and error-prone, or hardcoded validation rules embedded in application code, which cannot adapt to different jurisdictional requirements without code modification. Neither approach enables business users to self-serve compliant workflow creation, and both fail to provide real-time feedback during workflow design that would allow immediate correction of compliance violations before workflow deployment.

The disclosed identity verification platform implements real-time compliance validation by applying jurisdiction-specific rules to the attribute management framework during workflow configuration. Compliance rules are modeled as policies that specify required dependencies (or prohibited dependencies) between task attributes. For example, a QES compliance rule might specify that a signature capture task configured for QES-level signing must have a dependency relationship with an identity verification task that outputs a verified government-issued identity attribute. As a user arranges tasks in the workflow generation interface, the platform continuously evaluates the current task arrangement and attribute linkages against applicable compliance rules based on the user-selected jurisdiction. If a compliance violation is detected—such as a QES signature task lacking a dependency to a qualifying IDV task—the platform provides immediate visual feedback in the workflow interface and prevents workflow generation until the violation is corrected. This real-time validation approach empowers non-expert users to create compliant workflows without legal consultation, reduces the risk of deploying non-compliant workflows that could expose the organization to regulatory penalties, and adapts to different jurisdictional requirements through configuration of compliance rule sets rather than code modification.

Embodiments of the present disclosure provide systems and methods for real-time verification of workflow tasks prior to their deployment within a workflow instance. This approach, which may apply rules associated with the attribute management framework, validates that workflow tasks meet key compliance and operational standards. For example, tasks associated with authentication or signing services can be assessed for compliance with regulations specific to a user-selected jurisdiction and with entity-enforced policies, such as restrictions on signature delegation. By applying predefined policies to the attribute management framework, the workflow platform adapts to user needs without requiring deep knowledge of corporate or regulatory standards. Policies can include one or more compliance rules with each compliance rule specifying whether a dependency or lack thereof between attributes is expected. Examples of verifying compliance of a workflow with compliance and operational standards are described in U.S. Provisional Patent Application No. 63/720,420 titled “Identity Verification Workflow Compliance Management,” which is hereby incorporated by reference in its entirety.

In identity verification and signing workflows, the appropriate level of verification rigor often depends on transaction-specific risk factors such as geolocation anomalies, velocity patterns, or transaction amounts. Conventional workflow systems address this through separate, independently maintained workflows for different risk levels (e.g., a “high-risk onboarding workflow” and a “low-risk onboarding workflow”). This approach creates significant technical challenges as workflow logic is duplicated across multiple workflow definitions, requiring synchronized updates when business rules change, shared tasks (such as final account creation) must be independently configured in each workflow, increasing the likelihood of configuration drift and inconsistent user experiences, and the system cannot dynamically select risk-appropriate paths at runtime based on real-time risk assessment, instead requiring upfront risk classification before workflow initiation.

The disclosed workflow platform addresses this problem through diverging navigation paths within a single workflow process instance, combined with risk-based dynamic task selection. A workflow can include a risk assessment task that evaluates risk factors (e.g., IP geolocation, device fingerprint, or transaction characteristics) and outputs a risk metric. Subsequent to the risk assessment task, the workflow can define multiple navigation paths, each associated with a risk threshold condition. For example, one path might be selected if the risk metric exceeds a specified threshold, triggering high-assurance tasks such as biometric liveness detection and document verification, while an alternative path is selected for risk metrics below the threshold, utilizing lower-friction tasks such as email verification. Critically, the attribute management framework allows tasks in different navigation paths to output attributes with compatible types (e.g., both paths output a “verified_identity” attribute), enabling subsequent tasks that converge after the branching point to link to these attributes regardless of which path was executed. This architecture eliminates workflow duplication by consolidating divergent logic within a single workflow definition, provides consistent configuration of shared tasks, and allows for true dynamic risk-based path selection at workflow execution time based on real-time assessment results rather than predetermined classifications.

In accordance with aspects of the present disclosure, integration of diverging navigation paths in a workflow are provided. The workflow platform allows users to define two or more navigation paths (e.g., branching workflows) within a single workflow instance based on real-time conditions (e.g., risk levels, user roles) and/or end-user input. This functionality reduces the complexity of managing separate workflows for differing outcomes by consolidating branching logic within a single workflow project. For example, a workflow instance can include a navigation screen task allowing an end user to choose between face biometrics, a soft token push, or a passkey for authentication. Subsequent workflow tasks can dynamically link to attributes associated with the selected path, adapting to the user preference or context. In such examples, each navigation path can be configured independently.

In embodiments, if navigation paths converge, the workflow platform can update its real-time verification processes to ensure the integrity and consistency of subsequent tasks, regardless of the branch previously followed. For example, the workflow platform can aggregate and compare attribute data output from each navigation path.

Embodiments of the present disclosure provide for diverging navigation paths based on dynamic thresholds and policies. Navigation paths may be selected, for example, based on a determined risk metric. The risk metric can be based on an assessment of risk factors when the workflow is implemented. Risk factors can include, for example, one or more of: date, time, geolocation, travel velocity, location history, transaction risk, or external risk. For example, a time of a desired transaction can be compared to historical transaction data (e.g., associated with the account) to detect anomalous behavior.

In embodiments, the weights applied to risk factors to determine risk thresholds and/or risk metrics can be selected by the user during workflow creation. In some instances, weights may be automatically applied based on a policy or template. Precise risk balancing improves the versatility of the workflow platform, particularly in identity verification (IDV) or authentication contexts. For example, different authentication tasks (e.g., navigation paths) can be offered to an end user based on a determined risk metric associated with an end user.

From a security perspective, real-time risk assessment allows the workflow platform to allocate appropriate verification measures based on the assessed risk. For high-risk users, the workflow can automatically introduce more stringent checks, such as biometric or identity document verification. Conversely, for low-risk users, lighter verification steps (e.g., workflow tasks with low user friction) can be applied. This adaptive approach optimizes resource utilization by directing computational and operational efforts where they are most needed.

In terms of user experience, the adaptability of security measures reduces disruptions for low-risk users by avoiding overly rigorous verification processes, leading to faster task completion and improved satisfaction. For high-risk scenarios, the system ensures thorough verification without compromising the integrity of the workflow, maintaining trust and compliance. Additionally, real-time, risk-based scaling allows the workflow instance to adapt to evolving user contexts, such as changes in location or behavior patterns, improving responsiveness and reliability over time.

In some instances, separate user interface elements are provided for configuration of workflow task behavior and configuration of workflow task attributes (e.g., attribute linking). By separating behavioral properties of a workflow task from attribute considerations, the risk of user error when customizing a workflow task is reduced.

Embodiments of the present disclosure provide for risk-based scaling of signature capture tasks. The workflow platform can apply different levels of signing to signature capture tasks, for example, based on the assessed risk associated with a user or transaction.

An electronic signature is a digital representation of a person's intent to sign a document. Basic forms of an electronic signature include typing a name, drawing a signature (e.g., with a finger or stylus on a touchscreen), and uploading an image of a handwritten signature. Basic electronic signatures are generally easy to use and sufficient for routine, low-risk transactions or agreements where simplicity and convenience are prioritized over stringent security measures.

An Advanced Electronic Signature (AES) is a type of digital signature that provides a higher level of security and authentication compared to basic electronic signatures. The AES is uniquely linked to the signatory because the signer is given sole control over the signature creation process, using methods like biometric verification or cryptographic keys. AES can detect any tampering after the signature is applied to verify the integrity of the signed document.

A Qualified Electronic Signature (QES) builds upon the AES by incorporating additional safeguards and meeting the strictest legal standards. A QES requires a qualified certificate issued by a certified trust service provider and must be created using a Qualified Signature Creation Device (QSCD). This ensures the highest level of assurance regarding the signer's identity and the authenticity of the signature. A QES may be considered legally equivalent to a handwritten signature in some jurisdictions.

High-assurance digital signing can be achieved by embedding IDV workflow tasks with signing processes, particularly through incorporation of diverging navigation paths and real-time risk assessments. For example, IDV tasks, such as biometric capture, can be used to identify a risk metric associated with a workflow instance. High risk scenarios may require an AES or QES signature capture task (e.g., depending on user specifications). Conversely, low-risk scenarios might allow for basic electronic signatures, prioritizing efficiency and user convenience.

In some embodiments, digital signing tasks can be used in risk assessment. For example, a user completing a QES signature capture task that incorporates biometric verification can negate the need to complete a designated biometric capture task later in a workflow instance.

In conventional digital signature systems, the level of signature assurance (e.g., basic electronic signature, advanced electronic signature (AES), or qualified electronic signature (QES)) is typically predetermined based on document type or organizational policy, without consideration of the actual identity verification rigor applied to the signer. This creates a technical disconnect as a high-value transaction may receive only a basic signature if the user has undergone robust biometric identity verification, resulting in unnecessary user friction when a QES process is subsequently required. Conversely, a low-risk transaction might trigger an unnecessarily complex QES process when the user's identity verification was minimal, wasting computational resources and degrading user experience. The inability to dynamically adjust signature type based on real-time identity verification results creates an inflexible system that fails to balance security assurance and user friction on a per-transaction basis.

The disclosed workflow platform addresses this problem through attribute dependency resolution between identity verification tasks and signature capture tasks within a unified workflow process instance. Specifically, the platform maintains a set of relationships between task attributes that allows a signature capture task to inherit and evaluate attributes from preceding IDV tasks (e.g., liveness detection results, biometric match scores, or document authenticity indicators) based on the temporal ordering of tasks in the workflow. When a signature capture task is executed, the workflow platform evaluates these inherited attributes against predefined thresholds to programmatically determine the appropriate signature type. For example, if a preceding biometric capture task yields a high-confidence match score above a specified threshold and a document verification task confirms government-issued ID authenticity, the workflow platform can automatically configure the signature capture task to utilize a basic electronic signature, as the combined IDV rigor provides sufficient assurance. Conversely, if IDV results indicate lower confidence levels, the platform escalates to an AES or QES signature type by dynamically modifying the signature capture task configuration before execution. This dynamic linkage between IDV task outputs and signature task configuration addresses the technical disconnect present in conventional systems, providing real-time optimization of security assurance versus user friction on a per-workflow-instance basis.

Identity verification and digital signing workflows often require coordination among multiple specialized third-party services, such as risk assessment providers, biometric authentication systems, and cryptographic signature services, each implementing distinct application programming interfaces (APIs) with different data formats, authentication protocols, and error handling mechanisms. In conventional approaches, integrating these heterogeneous services into a cohesive workflow requires substantial developer expertise: programmers must manually write integration code to transform data between incompatible formats, implement service-specific authentication flows, handle divergent error responses, and maintain synchronization across service calls. This technical complexity creates several barriers, including, for example, organizations without in-house development resources cannot implement multi-service workflows, workflow modifications require code changes and redeployment, preventing business users from iterating on workflow logic, and each additional service integration exponentially increases code complexity and maintenance burden.

The disclosed workflow platform solves this integration complexity through a unified attribute management framework that abstracts heterogeneous service APIs behind a consistent task-based interface. When a third-party service is integrated with the workflow platform, the platform maps the service's API parameters to standardized task attributes within the framework. For example, a risk assessment service API requiring fields such as user_id, signup_time, and email_address is mapped to corresponding task attributes that can accept data from any preceding workflow task. During workflow execution, the platform automatically performs data format transformations, authentication token injection, and error handling based on service-specific integration logic encapsulated at the platform level, rather than requiring custom code in each workflow. Users configure workflows through a graphical interface by arranging task elements and linking task attributes via drag-and-drop operations. The identity verification platform then infers the necessary service API calls and data transformations based on the temporal order of tasks and the defined attribute dependencies. This approach eliminates the need for programming expertise, enables rapid workflow iteration by non-technical users, and reduces integration complexity to a constant factor regardless of the number of services integrated, as each service's complexity is encapsulated within the platform's integration layer rather than distributed across individual workflows.

In accordance with aspects of the present disclosure, integration of services into a workflow and dynamic generation of workflows including integrated service tasks is provided. In example aspects, a workflow platform is configured to support authentication and signing tasks. For example, an authentication service can be integrated with a workflow platform. In embodiments, an application programming interface implemented by the service is integrated at the workflow platform, allowing the workflow platform to communicate with the integrated service. As described herein, integrated services may include, for example, a risk assessment service, a document signature service, and an authentication service.

In some embodiments, a workflow platform provides a workflow interface for dynamic customization of a workflow. For example, a user may add, remove, or modify tasks of a workflow. The tasks available to be included in the workflow may include tasks associated with an integrated service. For example, the user may add a task to perform risk assessment of an applicant, which may rely on an integrated risk assessment service. During execution of the workflow, one or more tasks may be performed, at least in part, by the integrated service.

By integrating workflow tasks to achieve coordination with other services, users can create and execute workflows that address all of their needs in one integrated tool. The integrated services may be configured to perform operations that the workflow platform is not configured to perform, expanding the library of tasks available to the user.

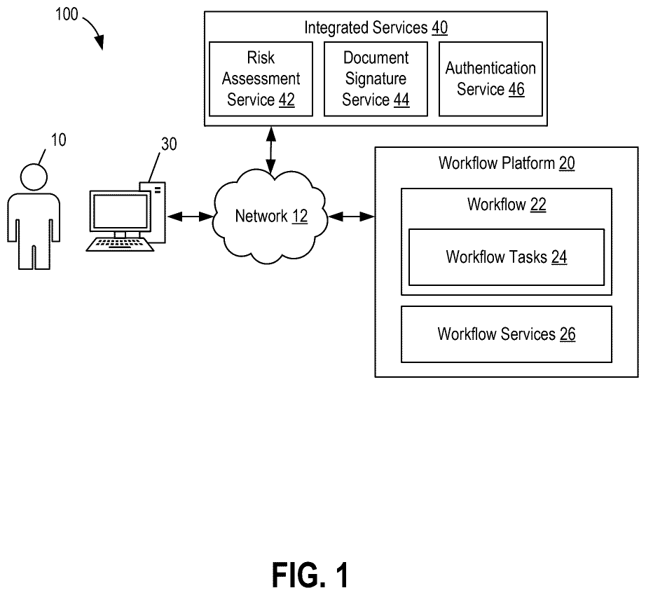

Referring to FIG. 1, an example system 100 for generation and use of a workflow is provided. In the illustrated embodiment, the system 100 includes a workflow platform 20, a computing device 30, and integrated services 40.

The computing device 30 comprises an electronic device in communication with other components of the system 100. For example, the computing device 30 may be connected to the workflow platform 20 over a network 12, such as the Internet. In an example, computing device 30 can be desktop computer, a laptop computer, tablet, mobile computing device, server, workstation, or Internet-of-things (IoT) device, among other electronic devices. Though depicted as a single computing device, the system 100 can, in other embodiments, include a plurality of computing devices 30, such as a networked system of devices, accessible by one or more users 10.

In an embodiment, as illustrated in FIG. 1, the workflow platform 20 is implemented on a single device, having its own processor and memory. In embodiments, the workflow platform 20 can include a distributed network of multiple computing devices (e.g., with each device having its own processor and memory). Similarly, each integrated service 40 may operate on a server or a distributed network of servers.

As described herein, a user 10 may generate a workflow 22 that may be used for security operations, such as identity verification and authentication. In other examples, the workflow 22 may be used to secure a digital document signature. While the examples herein describe the workflow 22 as a security workflow, in other embodiments, other types of workflows may be generated. For example, workflows for issuing digital or physical credentials may be generated using the systems and method described herein.

The workflow 22 may include one or more workflow tasks 24 that are performed during execution of the workflow 22. In examples, the tasks 24 may include an executable action to be taken by a client device (e.g., the computing device 30) during execution of the workflow 22. The tasks 24 may also include one or more attributes of the executable action. For example, the attributes may define data associated with the executable actions, such as inputs and outputs of the executable action.

In the illustrated embodiment, the user 10 may build the workflow 22 using a computing device 30 connected to a workflow platform 20 over a network 12 (e.g., the Internet). For example, as described further herein, the computing device 30 may present a workflow interface through which the user 10 can design the workflow 22. In example embodiments, the workflow interface allows the user 10 to configure the workflow 22 in a drag-and-drop manner, allowing the user 10 to order and connect the workflow tasks 24 within the workflow 22 without the user 10 needing programming expertise. In examples, a temporal order of the tasks 24 within the workflow 22 may be determined based on an arrangement of the tasks 24. For example, the tasks 24 may be arranged vertically, with tasks 24 arranged higher in the workflow interface being performed earlier during execution of the workflow. Attributes of the tasks 24 may also be configured in the workflow interface. In examples, attributes of tasks 24 may be linked to attributes of other tasks 24 within the workflow 22. For example, user data collected in an onboarding identity verification (IDV) task may also be used to populate a name field in a subsequent signature task. Accordingly, an attribute of the signature task that defines a name of a signer may be linked to an attribute of the IDV task that similarly defines the name. In embodiments, the attributes of the tasks 24 may be defined by the user 10. Additionally or alternatively, the attributes of the tasks 24 may automatically be defined based on the temporal order of the tasks 24 and a relationship between attributes. Using the example above, the name attribute for the signature task may automatically be linked to the name attribute of the IDV task based on the signature task being performed after the IDV tasks and the attributes being related—i.e., both attributes being name attributes.

The workflow 22 may include a plurality of workflow tasks 24 associated with different types of operations. For example, the workflow 22 may include workflow tasks 24 to perform a combination of identity verification, user risk assessments, secure digital document signing, and user authentication. In an example, the workflow platform 20 may be an identity verification server and include workflow services 26 configured to perform identity verification services. However, the workflow services 26 may not be configured to perform every workflow task 24 in the workflow 22. For example, if the workflow platform 20 is an identity verification server, the workflow services 26 may not be configured to perform user risk assessments, secure digital document signing, and user authentication.

To enable additional workflow tasks 24 beyond the operations for which the workflow services 26 are configured, the workflow platform 20 may be connected with one or more integrated services 40. For example, the integrated services 40 may include a risk assessment service 42 configured to perform user risk assessments, a document signature service 44 configured to perform secure digital document signing, and an authentication service 46 configured to perform user authentication. While the illustrated embodiment shows the risk assessment service 42, the document signature service 44, and the authentication service 46 as part of the integrated services 40, in alternative embodiments, the integrated services 40 may include a subset of the risk assessment service 42, the document signature service 44, and the authentication service 46. Similarly, in some embodiments, the integrated services 40 may include additional or alternative services configured to perform operations associated with workflow tasks 24 included in a workflow 22.

In embodiments, the workflow platform 20 is connected with the integrated services 40 over the network 12. In an example, the workflow platform 20 may be configured to integrate application programming interfaces (APIs) or other connection protocols implemented by the integrated services 40, allowing the workflow platform 20 to use features of the integrated services 40 for workflow tasks 24.

By integrating the capabilities of the integrated services 40 with the workflow platform 20, the workflow platform 20 may allow the user 10 to generate a workflow 22 incorporating workflow tasks 24 configured to perform a variety of different operations, even if the workflow 22 includes workflow tasks 24 that cannot be performed by the workflow services 26 of the workflow platform 20. The integration between the workflow platform 20 and the integrated services 40 therefore allows the user 10 to create workflows 22 at the workflow platform 20 that can be executed to perform each of the workflow tasks 24 needed by the user 10, rather than requiring the user 10 to create separate workflows at a plurality of platforms that are each configured for one type of operation.

In another example, the system 100 may be used to perform execution of the generated workflow 22. For example, the user 10 may use the computing device 30 to open an account for a secure resource, access the secure resource, or digitally sign a document. As the user performs these jobs, the workflow platform 20 may execute a corresponding workflow 22. When during execution of the workflow 22, the workflow 22 may progress through a series of workflow tasks 24 to complete the workflow 22. As described above, one or more of the workflow tasks 24 may be performed on the workflow platform 20 by a workflow service 26 while other tasks may be performed, at least in part, by an integrated service 40. When the workflow 22 progresses to a workflow task 24 that requires an integrated service 40, the workflow platform 20 may use an API associated with the integrated service 40 to allow the integrated service 40 to perform the workflow task 24.

In a first example, the user 10 may attempt to create an account for a secure resource (e.g., an application). A workflow 22 may execute on the workflow platform 20 for the account creation process. In an embodiment, the workflow 22 for account creation may include a workflow task 24 to assess the risk of the creating an account for the user 10. In this example, the workflow platform 20 may use the integrated risk assessment service 42 to perform the risk assessment of the user 10. As described herein, the workflow 22 may collect the necessary inputs for the risk assessment service 42 and transmit the inputs to the risk assessment service 42. The risk assessment service 42 may use the inputs to calculate a risk score for the user 10, which the risk assessment service 42 may return to the workflow platform 20. The workflow 22 for account creation may progress with different workflow tasks 24 executing based on the risk score calculated by the risk assessment service 42.

In a second example, the user 10 may attempt to digitally sign a document, and a workflow 22 may execute on the workflow platform 20 for the digital signature process. To allow the user 10 to sign the document, the workflow platform 20 may use the integrated document signature service 44. The workflow platform 20 may send the document for signature to the document signature service 44 and received a signed document back from the document signature service 44 after the user 10 signs the document. In some cases, digital signature of documents may be combined with other tasks integrated by the workflow platform 20, in various combinations and/or orders.

In a third example, the user 10 may attempt to register and use an authenticator. The authenticator may be used, for example, to authenticate the user 10 when the user 10 accesses a secure resource (e.g., an application). The workflow platform 20 may receive inputs necessary to register an authenticator and provide the inputs to the authentication service 46, which registers the authenticator. When the user 10 uses the authenticator for an authentication workflow task 24, the workflow platform 20 may work with the authentication service 46 to authenticate data from the user (e.g., a biometric token).

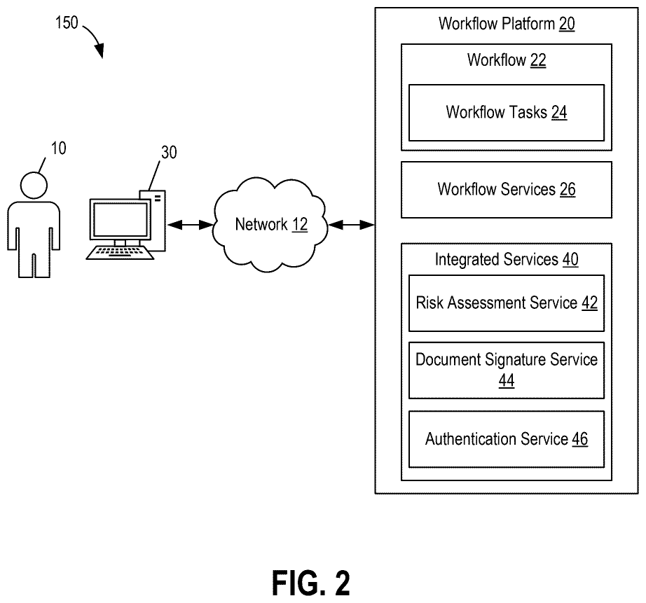

FIG. 2 illustrates another example system 150 for generation and use of a workflow. Like the system 100 described above in connection with FIG. 1, the system 150 includes a workflow platform 20, a computing device 30, and integrated services 40. Unlike the system 100 described above, in the illustrated example, the integrated services 40 are included on the workflow platform 20. For example, as the workflow platform 20 grows, additional features may be added to the workflow platform 20 by developing the integrated services 40 for execution within the workflow platform 20.

During creation of a workflow 22, the system 150 may operate similarly to the system 100 described above. A user 10 may configure the workflow 22 through a workflow interface presented on the computing device 30. The user 10 may add one or more workflow tasks 24 to the workflow 22 through the workflow interface in a drag-and-drop manner.

Similarly, during execution of the workflow 22, the system 150 may operate similarly to the system 100. As the workflow 22 proceeds through the workflow tasks 24, one or more of the workflow tasks 24 may be performed by workflow services 26 while other workflow tasks 24 may be performed by the integrated services 40, such as a risk assessment service 42, a document signature service 44, or an authentication service 46.

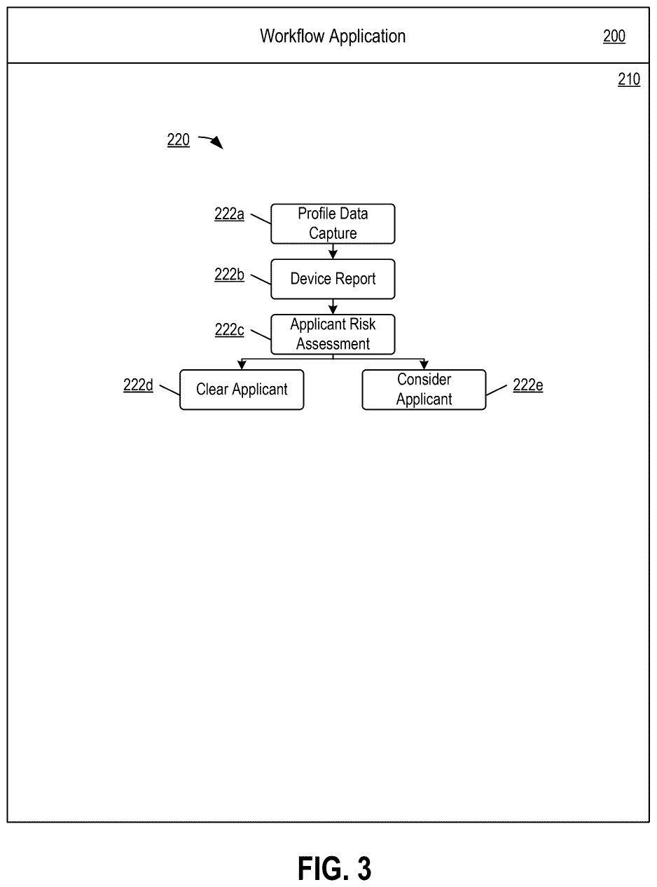

Turning to FIGS. 3-6, an example integration of a risk assessment service with a workflow platform is provided. FIGS. 3-5 illustrate an example workflow generation user interface 210 for generating a workflow 220 including a risk assessment task 222. The tasks 222 in the workflow may be represented the workflow generation user interface 210 by task elements (i.e., graphical representations) associated with the tasks 222. In the illustrated examples, the workflow generation user interface 210 is presented within a workflow application 200. In some embodiments, the workflow application may execute on a computing device, such as the computing device 30 described above in connection with FIGS. 1 and 2. In other embodiments, the workflow generation user interface 210 may be presented in browser executing on a computing device connected to a workflow platform, such as the computing device 30 connected to the workflow platform 20 described above.

FIG. 3 illustrates an example workflow 220 for opening an account for a user. In the illustrated example, the workflow 220 includes a plurality of workflow tasks 222, including a risk assessment task 222c. As described above, the workflow 220 may include some tasks 222 that are performed by workflow services of a workflow platform and some tasks 222 that are performed, at least in part, by integrated services. As described above, the integrated services may be external services or services included within the workflow platform. In this example, the risk assessment task 222c may be performed, at least in part, by an integrated risk assessment service. An arrangement of the tasks 222 within the workflow generation user interface 210 may define a temporal order of the tasks 222. For example, in the illustrated example, the tasks 222 are arranged vertically. In this example, during execution of the workflow 220, the tasks 222 may be performed from top to bottom—i.e., a profile data capture task 222a may be the first task 222 performed. Arrows between the tasks 222 may additionally or alternatively indicate a temporal order of the tasks 222.

The risk assessment task 222c may use data about a user to determine a risk of opening the account for the user. In example embodiments, the data used by the risk assessment task 222c includes a user identifier, a sign-up time, and contact information (e.g., an email or a phone number). Other data may additionally or alternatively be used by the risk assessment task 222c, including a name of the user, an address, and an IP address.

In the illustrated embodiment, the profile data capture task 222a and a device report task 222b may be used to collect data to be used by the risk assessment task 222c. For example, the profile data capture task 222a may require the user to input contact information (e.g., an email and a phone number), a name, and an address. The device report task 222b may analyze a device on which the user is attempting to open the account to determine an IP address of the device. Other data used by the risk assessment task 222c, such as the user identifier and the sign-up time, may be generated by the workflow platform when execution of the workflow 220 begins. For example, the sign-up time may be a time at which execution of the workflow 220 begins. The user identifier may be an identifier assigned to the user, and the user identifier may be used to identify the user across multiple executions of the workflow 220 and other workflows. During execution of the risk assessment task 222c, the workflow platform may format the data in a format specified by an API associated with the risk assessment service.

Using the input data, the risk assessment service may determine a risk score for the user. In an example, the risk score may be a score between 0 and 500, with a higher risk score indicating a higher risk if approving the applicant for the account. In alternative examples, different ranges may be used to represent the risk score. In some embodiments, in addition to the risk score, the risk assessment service may include additional information with the risk score, including a validity of the email address, a number of days since a domain of the email address was first observed by the risk assessment service, a creation date of the domain of the email address, a matching status of the email address and the name, an indicator that the IP address is risky, a risk score for the IP address, a number of days since the IP address was observed by the risk assessment service, a country code of the IP address, a geolocation subdivision of the IP address, a distance between the location of the IP address and a location associated with the phone number, a distance between the location of the IP address and a location associated with the address, a validity of the phone number, a type of phone number (e.g., landline, mobile, toll-free, etc.), a carrier associated with the phone number, a country code of the phone number, a number of days since the phone number was observed by the risk assessment service, a number of days since a combination of the phone number and email address was observed by the risk assessment service, a matching status of the phone number and the name, a matching status of the phone number and the address, a validity of address, and a matching status of the address and the name.

The risk score returned by the risk assessment service may be evaluated during the risk assessment task 222c to determine how to proceed through the workflow 220. For example, a risk score threshold may be defined in the configuration of the risk assessment task 222c. If the risk score returned by the risk assessment service is less than the threshold defined in the risk assessment task 222c, the user may be cleared, and the workflow may proceed to a task 222d to clear the user. Conversely, if the risk score is greater than or equal to the threshold defined in the risk assessment task 222c, the user may not be cleared, and more evaluation of the user may need to be performed through a task 222e.

While FIG. 3 illustrates an example workflow 220 that includes a risk assessment task 222c performed, at least in part, by a risk assessment service, in alternative examples, the workflow 220 may include additional or alternative tasks 222. For example, the workflow 220 may include one or more tasks 222 for identity verification if the risk assessment task 222c determines that the user is a high risk (i.e., the risk score returned by the risk assessment service is greater than or equal to the predefined risk score threshold).

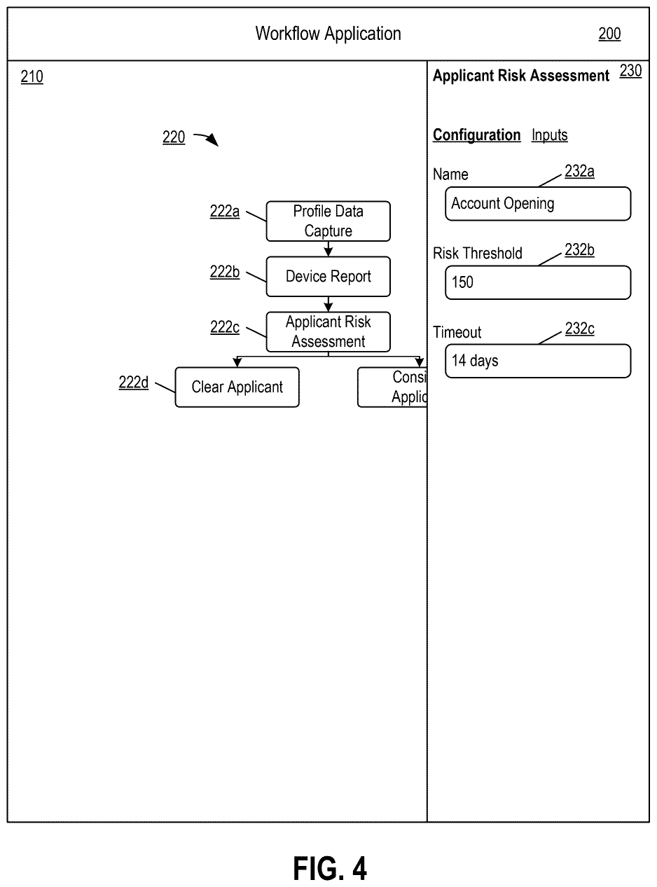

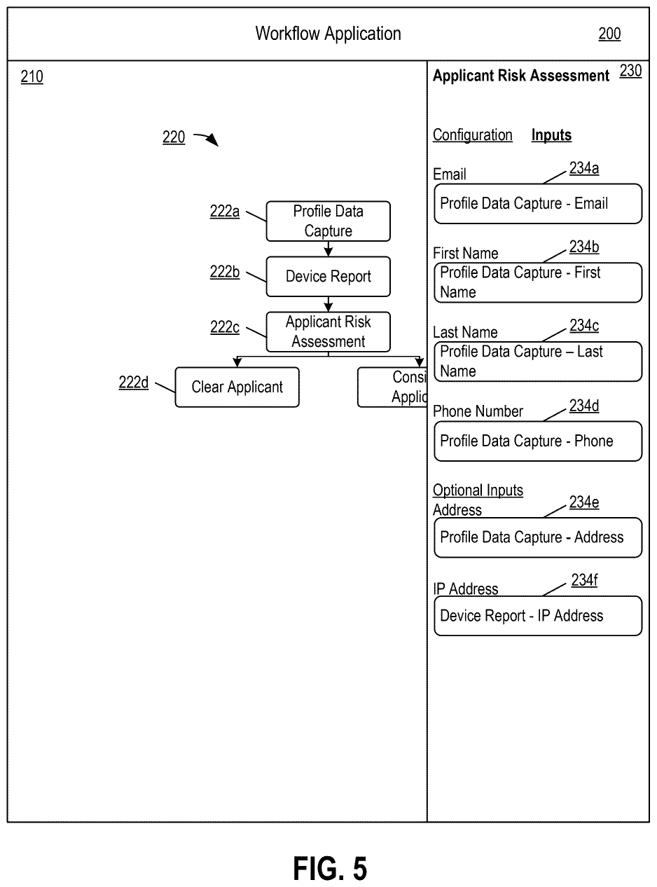

FIGS. 4 and 5 illustrate an example task configuration interface 230 presented in the workflow generation user interface 210. In the illustrated example, the task configuration interface 230 can be used by a user to configure the risk assessment task 222c described above. For example, the task configuration interface 230 may include options for the user to change attributes of the risk assessment task 222c, such as a configuration of the risk assessment task 222c and inputs of the risk assessment task 222c.

FIG. 4 illustrates the task configuration interface 230 when changing the configuration of the risk assessment task 222c. In the illustrated example, the task configuration interface 230 includes options to define a name of the task, a risk score threshold, and a timeout period for the task. The user may use inputs 232 to change values for these options. In the illustrated example, the risk score threshold is set to 150, and the user may use the input 232b to change the threshold. In an example, setting a higher risk score threshold may allow applicants with a higher risk to be approved.

FIG. 5 illustrates the task configuration interface 230 when changing the inputs of the risk assessment task 222c. As described above, data used by the risk assessment service may include a user identifier, a sign-up time, contact information (e.g., an email or a phone number), a name of the user, an address, and an IP address. The task configuration interface 230 may include inputs 234 allowing the user to define how the data used by the risk assessment service, or a portion thereof, is connected. In the illustrated example, an email address, name, phone number and address may be captured by the profile data capture task 222a, and the IP address may be captured by the device report task 222b. In embodiments, the inputs 234 for attributes that receive the data from a previous task identify both the task from which the data is inherited as well as the attribute of that task from which the data is inherited. For example, in the illustrated embodiment, the email address is inherited from an email address attribute of the profile data capture task 222a. In embodiments, by linking attributes of tasks 222 to attributes of previous tasks 222, execution of the workflow 220 may be more efficient for a user data can be shared between tasks 222 rather than requiring the user to input the same information multiple times.

Additionally, as shown in FIG. 5, some of the inputs for the risk assessment task 222c may be optional, such as the address and the IP address. In embodiments, the inputs that are required for the risk assessment task 222c and the inputs that are optional for the risk assessment task 222c are defined by the risk assessment service. For example, data that is required by the risk assessment service for calculating a risk score may be associated with a required input of the risk assessment task 222c. Similarly, data that is optional for the risk assessment service may be associated with an optional input for the risk assessment task 222c.

In examples, a validity of the workflow 220 may be determined based on the defined attributes of each task 222. For example, for the workflow 220 to be valid, the attributes for each task 222 may need to be defined—e.g., each input for a task 222 must be defined. Similarly, dependencies between tasks 222 may require the tasks 222 to be arranged in a specific temporal order, and these dependencies may need to be satisfied for the workflow 220 to be valid. For example, in the illustrated embodiment, the email attribute of the risk assessment task 222c receives the associated data from a corresponding email attribute of the profile data capture task 222a. In this example, for the workflow 220 to be valid, the risk assessment task 222c must be arranged such that the risk assessment task 222c is performed after the profile data capture task 222a. In examples, the workflow 220 may only be generated if it is valid. In embodiments, compliance of the workflow 220 with one or more identified regulatory standards or policies may additionally or alternatively be confirmed during creation of the workflow 220. In these embodiments, the workflow 220 may only be generated if it is compliant with the identified standards and policies.

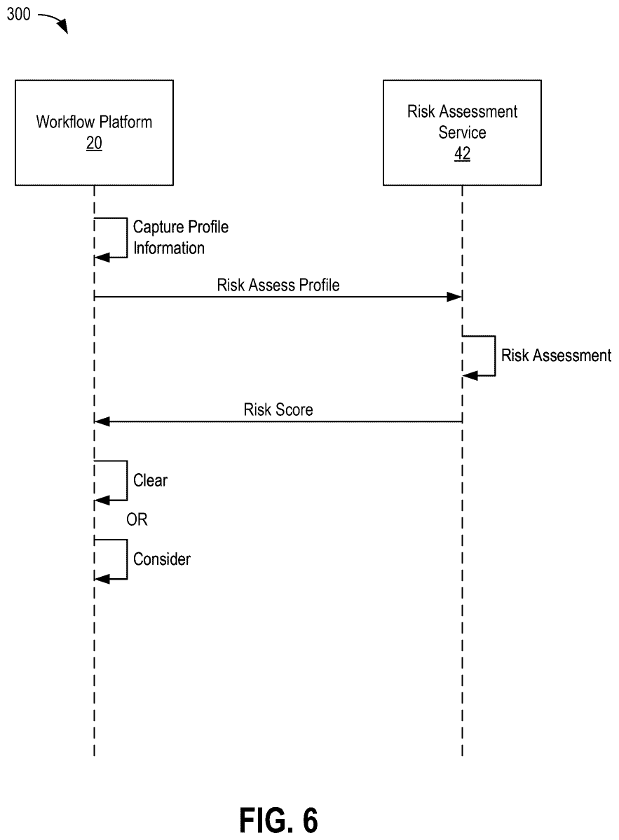

FIG. 6 illustrates an example message flow diagram 300 for determining a risk score for a user. In the illustrated example, the message flow diagram 300 shows communications between a workflow platform 20 and a risk assessment service 42 to determine a risk score for a user. In an example, the workflow platform 20 may communicate with the risk assessment service 42 during execution of a workflow configured at the workflow platform 20. In embodiments, the workflow platform 20 integrates an API implemented by the risk assessment service 42 to facilitate communication with the risk assessment service 42.

The workflow platform 20 captures profile information for the user. As described above, the profile information captured by the workflow platform 20 may include data about the user that the risk assessment service 42 uses to calculate risk score. In an embodiment, the profile information captured by the workflow platform 20 includes a user identifier, a sign-up time, contact information (e.g., an email or a phone number), a name of the user, an address, and an IP address.

In example embodiments, the profile information is captured during tasks of the workflow. For example, as described above, the user identifier and the sign-up time may be determined when the workflow is initialized. The contact information, name, and address may be input by the user during a profile data capture task. The IP address may be captured during a device report task.

The workflow platform 20 transmits the profile information to the risk assessment service 42 during a risk assessment task. As described above, the profile information may be transmitted to the risk assessment service 42 using the API associated with the risk assessment service 42. Using the received profile information, the risk assessment service 42 may calculate a risk score for the user indicating a risk associated with allowing the user to open an account or take other actions. In an example, the risk score is an integer value ranging from 0 to 500, with a higher risk score indicating a higher risk for the user. As described above, in some embodiments, the risk assessment service 42 may additionally determine one or more other values indicative of the risk associated with the user.

The risk assessment service 42 transmits the calculated risk score to the workflow platform 20. Using the calculated risk score, the workflow platform 20 may clear the user or indicate that further evaluation of the user is needed (e.g., by a human administrator). In an embodiment, the risk score is compared against a predefined risk score threshold. If the risk score is less than the threshold, the user is cleared, and if the risk score is greater than or equal to the threshold, the user is marked for further consideration.

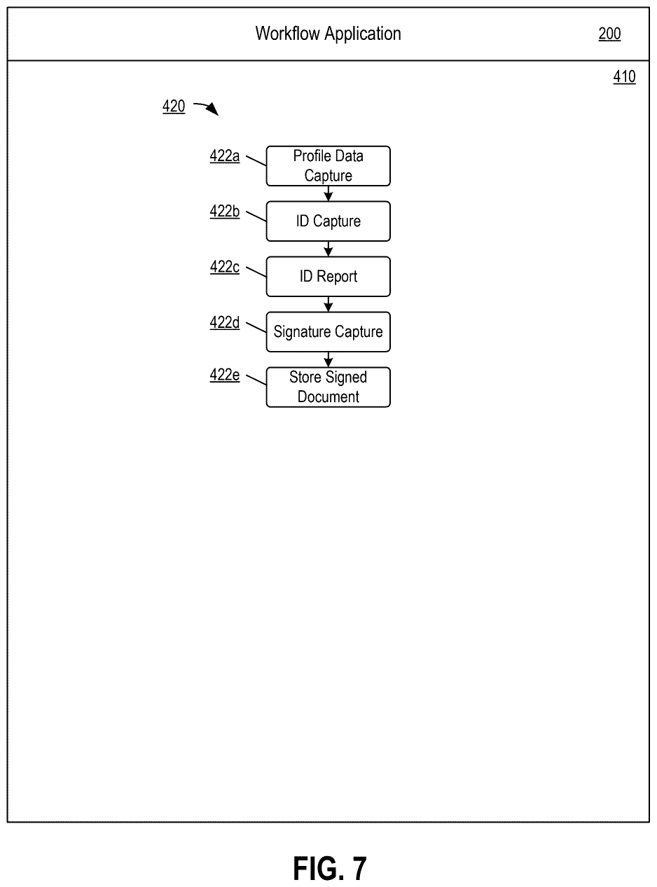

Turning to FIGS. 7-10, an example integration of a document signature service with a workflow platform is provided. FIGS. 7-9 illustrate an example workflow generation user interface 410 for generating a workflow 420 including a task 422 for capturing a digital signature. The tasks 422 in the workflow may be represented the workflow generation user interface 410 by task elements (i.e., graphical representations) associated with the tasks 422. In the illustrated examples, the workflow generation user interface 410 is presented within a workflow application 200. In some embodiments, the workflow application may execute on a computing device, such as the computing device 30 described above in connection with FIGS. 1 and 2. In other embodiments, the workflow generation user interface 410 may be presented in browser executing on a computing device connected to a workflow platform, such as the computing device 30 connected to the workflow platform 20 described above.

FIG. 7 illustrates an example workflow 420 for capturing a digital signature for a document. In the illustrated example, the workflow 420 includes a plurality of workflow tasks 422, including a signature capture task 422d. As described above, the workflow 420 may include some tasks 422 that are performed by workflow services of a workflow platform and some tasks 422 that are performed, at least in part, by integrated services. As described above, the integrated services may be external services or services included within the workflow platform. In this example, the signature capture task 422d may be performed, at least in part, by an integrated document signature service. As described above, an arrangement of the tasks 422 within the workflow generation user interface 410 may define a temporal order of the tasks 422. For example, in the illustrated example, the tasks 422 are arranged vertically. In this example, during execution of the workflow 420, the tasks 422 may be performed from top to bottom.

In the illustrated example, a profile data capture task 422a, an ID capture task 422b, and an ID report task 422c are included in the workflow 420 for identity verification. Performing identity verification during the workflow 420 before the signature is captured may ensure that the person signing the document is who they claim to be. The profile data capture task 422a and the ID report task 422c also provide inputs to the signature capture task 422d that allow the signature to be captured, such as a name and an email address, as described further herein. After the document is signed during the signature capture task 422d, the signed document may be verified and stored during a document storage task 422e. In an example, a transaction identifier generated during the signature capture task 422d is used as an input for the document storage task 422e.

During the signature capture task 422d, a digital document is provided to the integrated document signature service. For example, a link to a digital document may be provided to the document signature service. In an example, an API is used to communicate with the integrated document signature service. Other information, such as an email address of the signer may be transmitted to the document signature service as well. For example, the document signature service may use the email address to send an email to the signer with a link to sign the document.

After the signer signs the document, the document storage task 422e may be performed to verify that the document was signed successfully and retrieve the signed document from the document signature service. A transaction identifier that is generated during the signature capture task 422d may be used during the document storage task 422e to verify with the document signature service that the document was signed successfully and to retrieve the signed document. The signed document may be stored in a database associated with the workflow platform, such as a cloud database.

In example embodiments, the workflow 420 may additionally include authentication or identity verification tasks, and the signature capture task 422d may depend on the authentication or identity verification tasks. For example, a type of signature captured during the signature capture task 422d may depend on a risk level determined based on the authentication or identity verification tasks. In an example, if a high risk score is determined from the authentication or identity verification tasks 422, a QES or AES signature may be captured during the signature capture task 422d. In this example, if a low risk score is determined from the authentication or identity verification tasks, a basic electronic signature may be captured during the signature capture task 422d. In embodiments, the workflow 420 may be a diverging workflow that includes diverging paths based on the authentication or identity verification tasks. For example, each path may include a signature capture task 422d configured for an appropriate signature type based on a calculated risk score.

Similarly, the signature capture task 422d may depend on a type of document being signed. In examples, a security level associated with the document may determine a type of signature—e.g., QES, AES, or basic signature—to be captured. Like with the authentication and identity verification tasks described above, the workflow 420 may include diverging paths based on the type of document that is being signed, with each path including a signature capture task 422d configured for an appropriate signature type. Alternatively, the signature capture task 422d may dynamically change the type of signature captured based on the document type.

In example embodiments, a signature capture task may not include a predefined signature type. When such a signature capture task is added to a workflow, the workflow platform can automatically determine a type of signature to assign the signature capture task based on, for example, regulatory requirements, workflow configuration, document characteristics, and user preferences. In some cases, for example if the workflow platform is unable to determine an applicable signature type, the workflow platform can prompt a user to select a signature type.

In some instances, regulatory requirements can be used to automatically select a signature type. For example, the platform can assess the legal or compliance standards applicable to the document or transaction or implicated by a selected compliance template. For example, certain agreements may require a QES to meet applicable legal standards

In some instances, workflow configuration can be used to automatically select a signature type. Users can configure workflows with predefined rules for signature types and risk thresholds. These rules and/or thresholds may specify whether a simple electronic signature, AES, or QES is required (e.g., throughout a workflow). Additionally, the workflow platform can assess whether another task in the workflow (e.g., a proceeding or subsequent task) would affect the signature type required. For example, based on attributes associated with a prior IDV task, the workflow platform can determine whether the identity of the end user has been rigorously verified.

In some instances, document characteristics, including document type and sensitivity, can be used to automatically select a signature type. A particular document type can be associated with a security level. Sensitive or high-value documents may require more robust signature types to ensure authenticity and security.

Different document types and regulatory contexts require different levels of signature assurance, but determining the appropriate signature type (basic, AES, or QES) requires knowledge of complex, jurisdiction-specific legal frameworks. For example, employment contracts in certain EU member states may require QES-level signatures, while internal approval documents may accept basic electronic signatures. In conventional digital signature systems, users must manually select the signature type for each workflow, requiring either legal expertise to interpret regulatory requirements or reliance on IT staff to configure signature settings. This creates a bottleneck in workflow creation and increases the risk of selecting an insufficient signature type that renders signed documents legally non-binding or selecting an overly stringent signature type that imposes unnecessary friction and cost.

Embodiments of the present disclosure provide for an identity verification platform that implements automatic signature type selection by evaluating multiple factors when a signature capture task is added to a workflow. In some examples, the platform first analyzes attributes of preceding tasks to determine the rigor of identity verification already performed. For example, if a high-assurance biometric IDV task is present, the platform may determine that sufficient signatory identification has occurred to support an AES signature. The platform may then evaluate document metadata (such as document classification or sensitivity tags) to determine the security level required; high-value or legally binding documents automatically trigger higher signature assurance levels. The platform can then apply jurisdiction-specific compliance templates that encode regulatory requirements for different document types in different legal frameworks; when a user selects a compliance template (such as “eIDAS-compliant EU workflow”), the platform consults the template's rules to determine minimum signature requirements. The platform programmatically combines these factors (IDV rigor, document characteristics, and regulatory requirements) to automatically configure the signature capture task with the appropriate signature type, or to prompt the user to select among compliant options if multiple valid choices exist. This automatic selection mechanism mitigates the need for legal expertise during workflow configuration, reduces the risk of compliance violations due to incorrect signature type selection, and optimizes user experience by avoiding unnecessarily stringent signature processes when lower-assurance methods satisfy regulatory requirements.

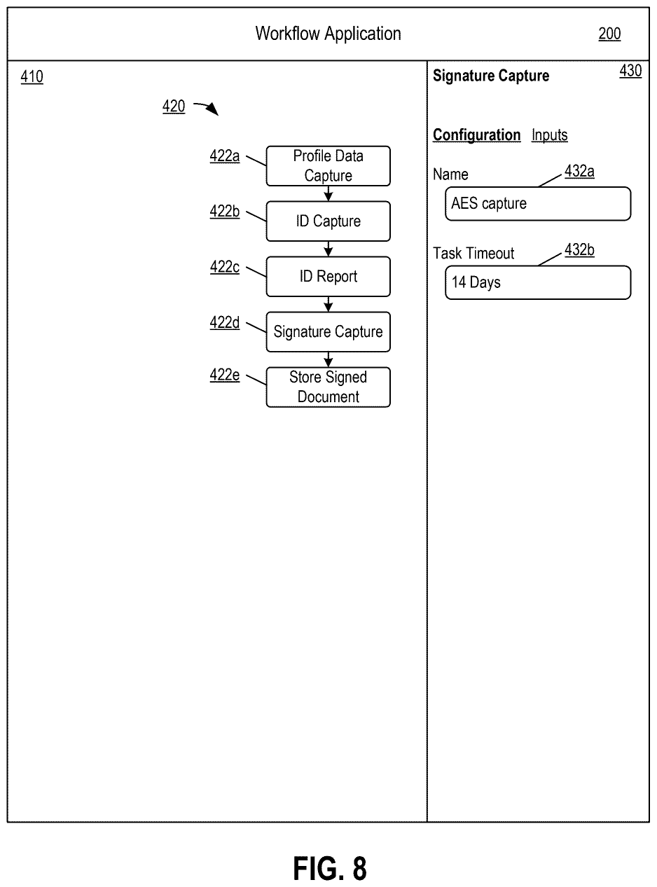

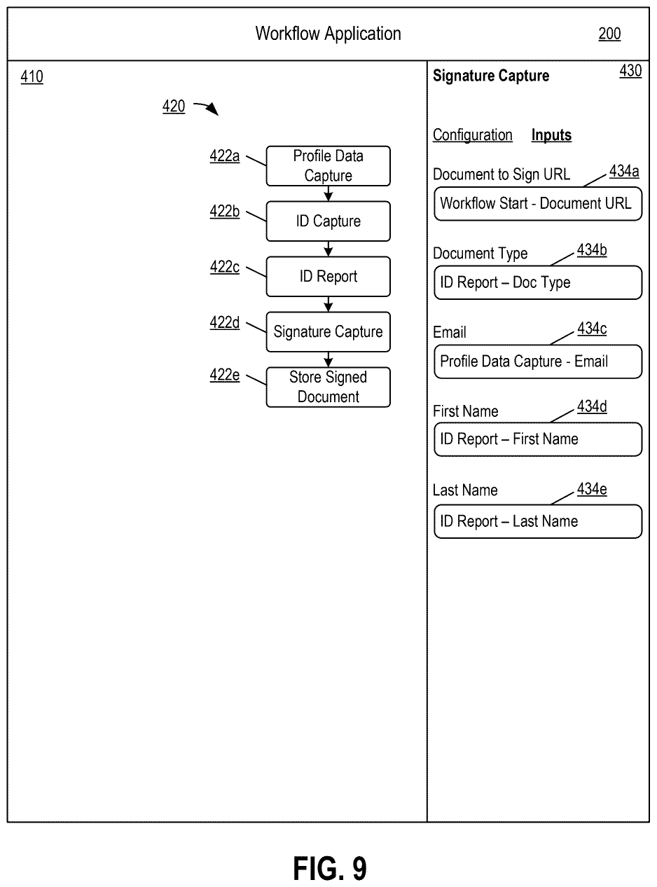

FIGS. 8 and 9 illustrate an example task configuration interface 430 presented in the workflow generation user interface 410. In the illustrated example, the task configuration interface 430 can be used by a user to configure the signature capture task 422d described above. For example, the task configuration interface 430 may include options for the user to change attributes of the signature capture task 422d, such as a configuration of the signature capture task 422d and inputs of the signature capture task 422d.

FIG. 8 illustrates the task configuration interface 430 when changing the configuration of the signature capture task 422d. In the illustrated example, the task configuration interface 430 includes options to define a name of the task and a timeout period for the task. The user may use inputs 432 to change values for these options. In alternative embodiments, the task configuration interface 430 may additionally or alternatively allow a user to define a type of signature to be captured during the signature capture task 422d—e.g., a basic electronic signature, an AES signature, or a QES signature. In some embodiments, the type of signature captured during the signature capture task 422d may automatically be determined based on a compliance and operational standards identified by a user. For example, if a compliance standard requires a QES signature to be captured for the workflow 420 to be compliant, the signature capture task 422d may automatically be configured to capture a QES signature.

In alternative examples, rather than the signature capture task 422d including an attribute allowing the type of signature to be defined, the workflow platform may include a plurality of signature capture tasks 422d that are each configured to capture a designated type of digital signature. For example, a first signature capture task 422d may capture QES signatures, a second signature capture task 422d may capture AES signatures, and a third signature capture task 422d may capture basic digital signatures. The user may then select the appropriate signature capture task 422d for the workflow 420. Similarly, the appropriate signature capture task 422d may automatically be selected or recommended for the workflow 420 based on identified compliance standards, a security level associated with documents to be signed using the workflow 420, or other similar factors.

FIG. 9 illustrates the task configuration interface 430 when changing the inputs of the signature capture task 422d. In examples, a link to the document to be signed and an email address of the signer are inputs to the signature capture task 422d. In some embodiments, additional or alternative information may be included as an input to the signature capture task 422d including a name of the signer and a type of document used during identity verification of the signer. The task configuration interface 430 may include inputs 434 allowing the user to define how the inputs, or a portion thereof, are captured. In the illustrated example, an email address may be captured by the profile data capture task 422a, the document link may be captured during initialization of the workflow 420, and the document type and signer name may be captured from the document report task 422c. In alternative embodiments, additional or alternative inputs may be used for the signature capture task 422d, and the inputs may come from different tasks 422 than shown in the illustrated example. As described above, the inputs 434 for attributes that receive the data from a previous task identify both the task from which the data is inherited as well as the attribute of that task from which the data is inherited. For example, in the illustrated embodiment, the document type is inherited from a document type attribute of the ID report task 422c.

As described above, a validity of the workflow 420 may be determined based on the defined attributes of each task 422. For example, because the signature capture task 422d includes attributes that inherit data from previous tasks 422—e.g., the document type is inherited from the ID report task 422c—the signature capture task 422d may be dependent on the previous tasks 422 (e.g., the ID report task 422c). Accordingly, the signature capture task 422d may need to be arranged within the workflow 420 to occur after the tasks 422 from which data is inherited for the workflow 420 to be valid. In examples, the workflow 420 may only be generated if it is valid. In embodiments, compliance of the workflow 420 with one or more identified regulatory standards or policies may additionally or alternatively be confirmed during creation of the workflow 420. In these embodiments, the workflow 420 may only be generated if it is compliant with the identified standards and policies.

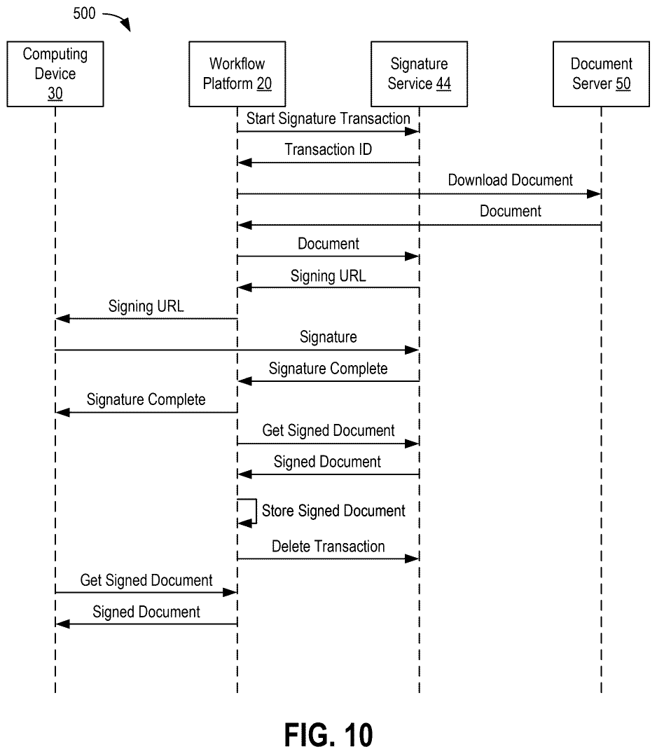

FIG. 10 illustrates a message flow diagram 500 for digitally signing a document. In the illustrated example, the message flow diagram 500 shows communications between a computing device 30, a workflow platform 20, a document signature service 44, and a document server 50. In an example, the workflow platform 20 may communicate with the document signature service 44 during execution of a workflow configured at the workflow platform 20. In embodiments, the workflow platform 20 integrates an API implemented by the document signature service 44 to facilitate communication with the document signature service 44.

The workflow platform 20 initiates a workflow for signing a document. The workflow platform 20 starts a signature transaction with the signature service 44, and the signature service 44 responds with a transaction identifier. In examples, the transaction identifier is used by the workflow platform 20 and the signature service 44 to track the document throughout the stages of the signature process described herein.

After initiating the signature transaction with the signature service 44, the workflow platform 20 transmits the document to be signed to the signature service 44. In the illustrated example, the document to be signed is stored on the document server 50. The workflow platform 20 may retrieve the document from the document server 50. For example, a link to the document may be provided to the workflow platform 20, and the workflow platform 20 may use the link to download the document. In another example, the workflow platform 20 may provide the link to the document to the signature service 44, and the signature service 44 may use the link to download the document. In a further example, a copy of the document may be provided to the workflow platform 20 or the signature service 44 from the computing device 30 or from another computing device.

The signature service 44 processes the document and prepares the document for signing. When the document is ready for signing, the signature service provides a signature link to the workflow platform 20, and the workflow platform 20 provides the signature link to the computing device 30. In embodiments, a signer of the document may use the signature link at the computing device 30 to access the document for signature. In examples, using the signature link at the computing device 30 causes the computing device 30 to present a user interface of the signature service 44 through which the signer can sign the document.

When the signer signs the document, the signature service 44 notifies the workflow platform 20 that the document is signed, and the workflow platform 20 notifies the computing device 30 that the document is signed. After the document is signed and the computing device 30 is notified, a signature capture task (e.g., the signature capture task 422d described above) in the workflow executed by the workflow platform 20 may be complete, and the workflow platform 20 may progress the workflow to a document storage task (e.g., the document storage task 422e described above).

During the document storage task, the workflow platform 20 may retrieve the signed document from the signature service 44. For example, the workflow platform 20 may use the transaction identifier generated by the signature service 44 to retrieve the signed document. In embodiments, when retrieving the signed document from the signature service 44, the workflow platform 20 may additionally retrieve a transaction receipt from the signature service 44. In an example, the transaction receipt may be used to verify that the document was signed properly. In some embodiments, a shared secret is also transmitted from the signature service 44. In an example, the shared secret may be used to validate content provided by the signature service 44. For example, the shared secret may be used for a checksum calculation for validation.

The workflow platform 20 stores a copy of the signed document and any associated documents retrieved from the signature service 44 (e.g., a transaction receipt). In an example, the signed document is stored in a database associated with the workflow platform 20. For example, the workflow platform 20 may store the document in a cloud database controlled by the workflow platform 20.

After receiving the signed document from the signature service 44, the workflow platform 20 may instruct the signature service 44 to delete the signed document and any associated transaction receipt from the records of the signature service 44. In an alternative example, the signature service 44 may automatically delete its records after the signed document is retrieved by the workflow platform 20. In some examples, the signature service 44 may automatically delete its records after a predetermined amount of time.

After the signed document is stored by the workflow platform 20, a user, such as the signer, can retrieve the signed document from the workflow platform 20. In an example, the user may use the computing device 30 to request the signed document from the workflow platform 20, and the workflow platform 20 may provide a link to the signed document to the computing device 30 from which the user may download the signed document.

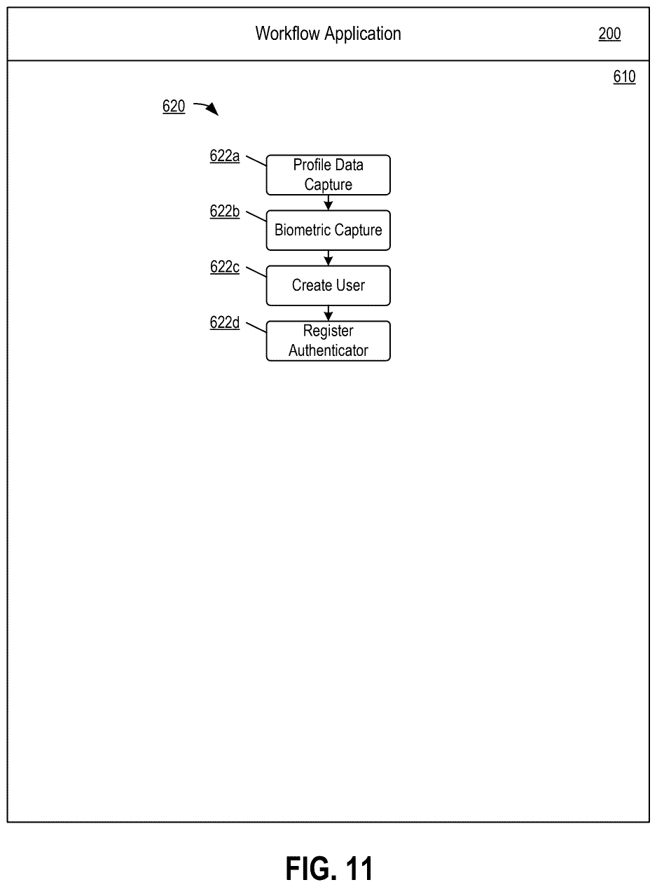

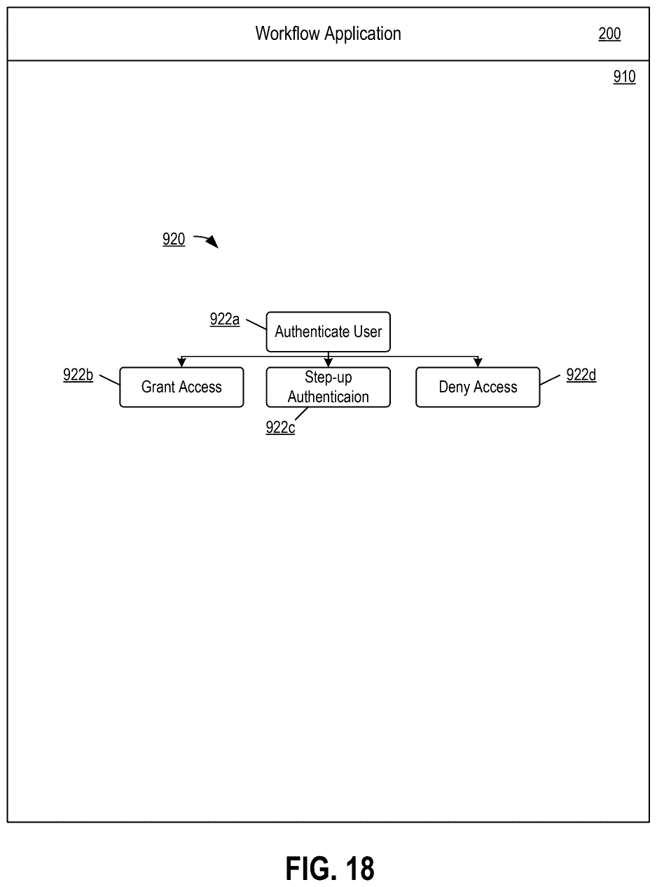

Turning to FIGS. 11-21, an example integration of an authentication service with a workflow platform is provided. FIGS. 11-17 illustrate creating a user with the authentication service and registering an authenticator with the authentication service, and FIGS. 18-21 illustrate using the authentication service to authenticate a user (e.g., using a registered authenticator).

FIGS. 11-15 illustrate an example workflow generation user interface 610 for generating a workflow 620 including tasks 622 to create a user at the authentication service and register an authenticator for the user with the authentication service. The tasks 622 in the workflow may be represented the workflow generation user interface 610 by task elements (i.e., graphical representations) associated with the tasks 622. In the illustrated examples, the workflow generation user interface 610 is presented within a workflow application 200. In some embodiments, the workflow application may execute on a computing device, such as the computing device 30 described above in connection with FIGS. 1 and 2. In other embodiments, the workflow generation user interface 610 may be presented in browser executing on a computing device connected to a workflow platform, such as the computing device 30 connected to the workflow platform 20 described above.

FIG. 11 illustrates an example workflow 620 for creating a user with an authentication service and registering an authenticator for the user with the authentication service. In the illustrated example, the workflow 620 includes a plurality of workflow tasks 622, including a user creation task 622c and an authenticator registration task 622d. As described above, the workflow 620 may include some tasks 622 that are performed by workflow services of a workflow platform and some tasks 422 that are performed, at least in part, by integrated services. As described above, the integrated services may be external services or services included within the workflow platform. In this example, the user creation task 622c and the authenticator registration task 622d may be performed, at least in part, by an integrated authentication service. As described above, an arrangement of the tasks 622 within the workflow generation user interface 610 may define a temporal order of the tasks 622. For example, in the illustrated example, the tasks 622 are arranged vertically. In this example, during execution of the workflow 620, the tasks 622 may be performed from top to bottom.

In the illustrated example, a profile data capture task 622a and a biometric capture task 622b may be included in the workflow 620 to capture data needed for other tasks 622 in the workflow 620, such as the user creation task 622c and the authenticator registration task 622d. In some examples, the workflow 620 may include additional or alternative tasks 622 for identity verification-e.g., to verify that the user creating the account and registering the authenticator is who they claim to be.

During the user creation task 622c, a user identifier is provided to the authentication service to create an account for the user. In some embodiments, additional information may also be used to create the user account including a name and contact information (e.g., an email address and a phone number). If the user identifier has not already been used for a user account at the authentication service, a user account may be created with the authentication service. Conversely, if the user identifier has already been used for a user account with the authentication service, the user creation task 622c may output an indicator that the user should be considered further, and an account is not created. Additionally, the user creation task 622c may output a unique user identifier that is generated by the authentication service, and the unique user identifier may be used to identify the user during future tasks 622, such as the authenticator registration task 622d.

The authenticator registration task 622d may be used to register an authenticator for the user with the authentication service. By registering an authenticator with the authentication service, the user may use the authenticator during future authentication tasks, as described further herein. In an example, the authenticator that is registered during the authenticator registration task 622 is a biometric authenticator, and the biometric data that is used for the biometric authenticator is captured during the biometric capture task 622b. For example, a biometric token may be created based on the biometric data captured during the biometric capture task 622b, and the biometric token may be registered with the authentication service.

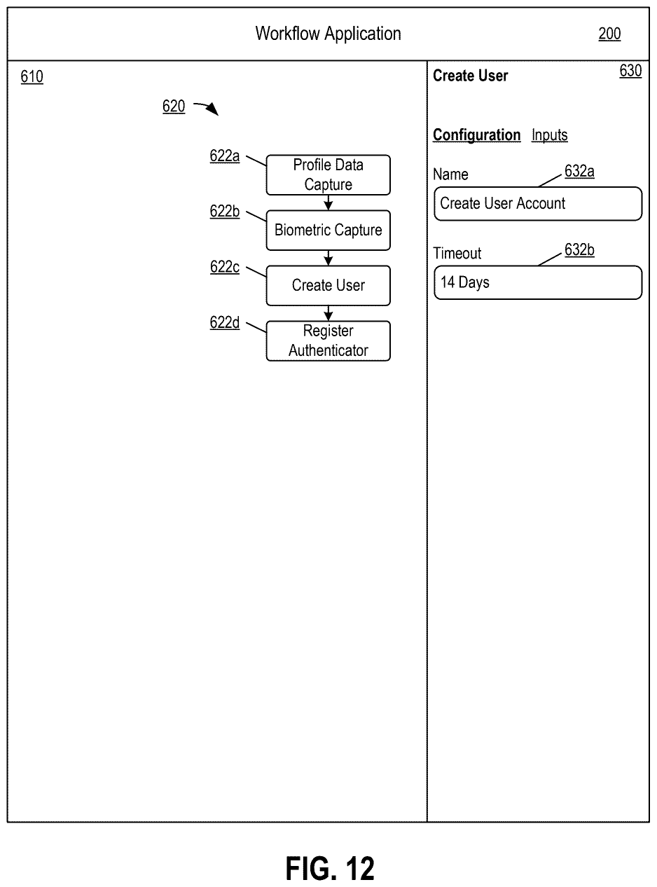

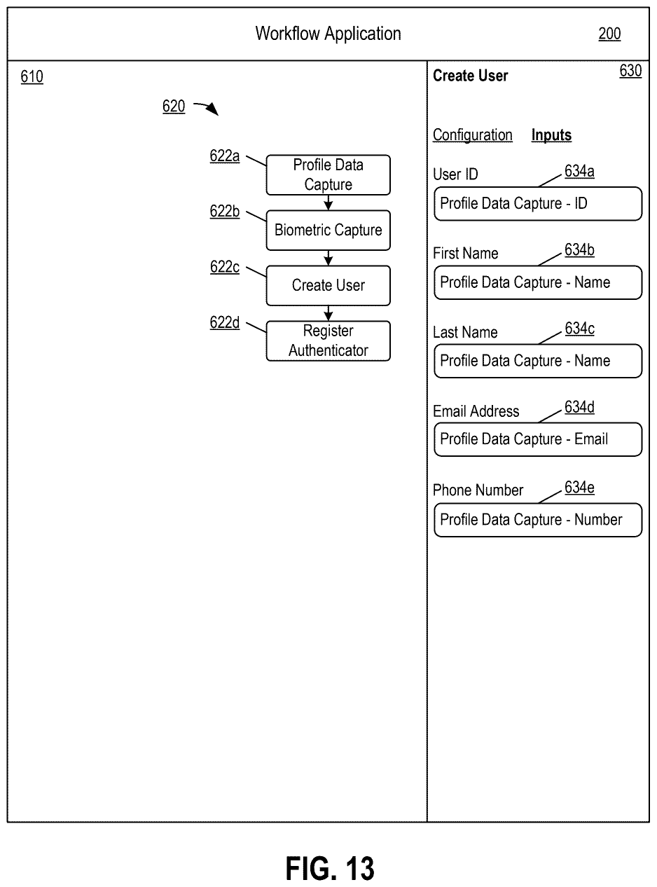

FIGS. 12 and 13 illustrate an example task configuration interface 630 presented in the workflow generation user interface 610. In the illustrated example, the task configuration interface 630 can be used to configure the user creation task 622c described above. For example, the task configuration interface 630 may include options for the user to change attributes of the user creation task 622c, such as a configuration of the user creation task 622c and inputs of the user creation task 622c.

FIG. 12 illustrates the task configuration interface 630 when changing the configuration of the user creation task 622c. In the illustrated example, the task configuration interface 630 includes options to define a name of the task and a timeout period for the task. The user may use inputs 632 to change values for these options.

FIG. 13 illustrates the task configuration interface 630 when changing the inputs of the user creation task 622c. In the illustrated example, the inputs include a user identifier, a name, an email address and a phone number. The task configuration interface 630 may include inputs 634 allowing the user to define how the inputs, or a portion thereof, are captured. In the illustrated example, each of the inputs may be captured during the profile data capture task 622a. As described above, the inputs 634 for attributes that receive the data from a previous task identify both the task from which the data is inherited as well as the attribute of that task from which the data is inherited. For example, in the illustrated embodiment, the user identifier is inherited from a user identifier attribute of the profile data capture task 622a.

As described above, a validity of the workflow 620 may be determined based on the defined attributes of each task 622. For example, because the user creation task 622c includes attributes that inherit data from previous tasks 622—e.g., the user identifier is inherited from the profile data capture task 622a—the user creation task 622c may be dependent on the previous tasks (e.g., the profile data capture task 622a). Accordingly, the user creation task 622c may need to be arranged within the workflow 620 to occur after the tasks 622 from which data is inherited for the workflow 620 to be valid. In examples, the workflow 620 may only be generated if it is valid. In embodiments, compliance of the workflow 620 with one or more identified regulatory standards or policies may additionally or alternatively be confirmed during creation of the workflow 620. In these embodiments, the workflow 620 may only be generated if it is compliant with the identified standards and policies.

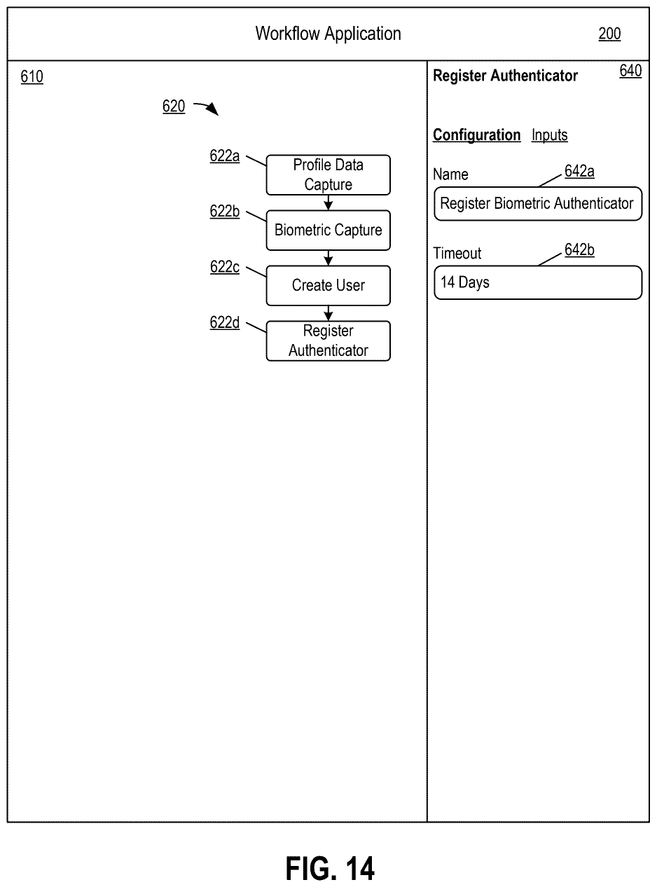

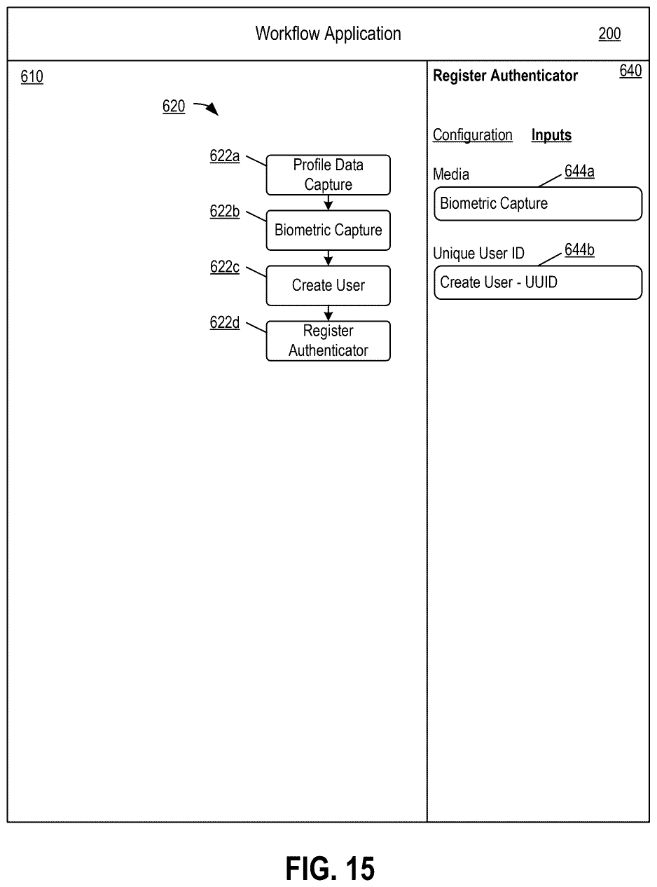

FIGS. 14 and 15 illustrate another example task configuration interface 640 presented in the workflow generation user interface 610. In the illustrated example, the task configuration interface 640 can be used to configure the authenticator registration task 622d described above. For example, the task configuration interface 630 may include options for the user to change attributes of the authenticator registration task 622d, such as a configuration of the authenticator registration task 622d and inputs of the authenticator registration task 622d.

FIG. 14 illustrates the task configuration interface 640 when changing the configuration of the authenticator registration task 622d. In the illustrated example, the task configuration interface 640 includes options to define a name of the task and a timeout period for the task. The user may use inputs 642 to change values for these options.

FIG. 15 illustrates the task configuration interface 640 when changing the inputs of the authenticator registration task 622d. In the illustrated example, the inputs include biometric media and a unique user identifier. The task configuration interface 640 may include inputs 644 allowing the user to define how the inputs, or a portion thereof, are captured. In the illustrated example, the biometric media may be an output of the biometric capture task 622b, and the unique user identifier may be an output of the user creation task 622c. As described above, the inputs 644 for attributes that receive the data from a previous task identify both the task from which the data is inherited as well as the attribute of that task from which the data is inherited. For example, in the illustrated embodiment, the unique user identifier is inherited from a unique user identifier attribute of the user creation task 622c.

As described above, a validity of the workflow 620 may be determined based on the defined attributes of each task 622. For example, because the authenticator registration task 622d includes attributes that inherit data from previous tasks 622—e.g., the unique user ID is inherited from the user creation task 622c—the authenticator registration task 622d may be dependent on the previous tasks 622 (e.g., the user creation task 622c). Accordingly, the authenticator registration task 622d may need to be arranged within the workflow 620 to occur after the tasks 622 from which data is inherited for the workflow 620 to be valid. In examples, the workflow 620 may only be generated if it is valid. In embodiments, compliance of the workflow 620 with one or more identified regulatory standards or policies may additionally or alternatively be confirmed during creation of the workflow 620. In these embodiments, the workflow 620 may only be generated if it is compliant with the identified standards and policies.

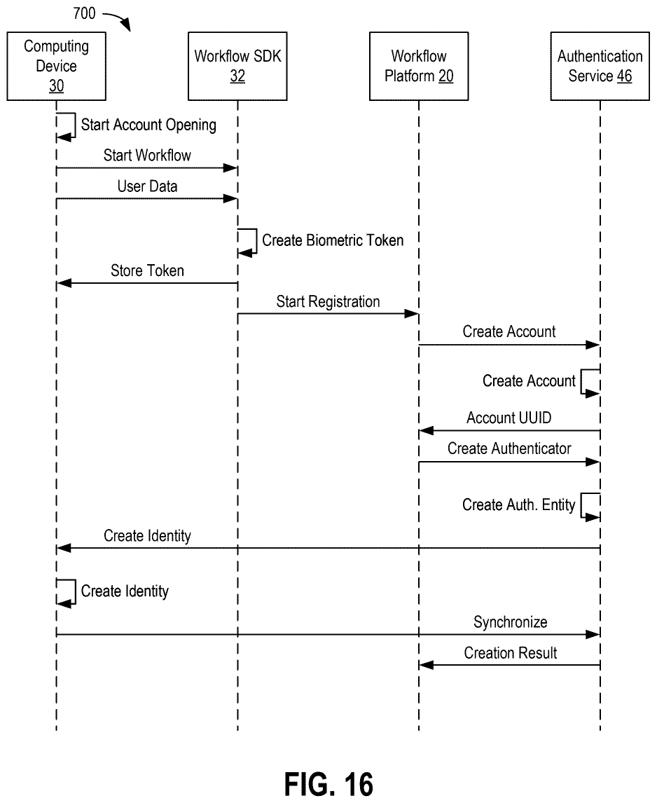

FIG. 16 illustrates a message flow diagram 700 for creating a user account and registering an authenticator with an authentication service. In the illustrated example, the message flow diagram 700 shows communications between a computing device 30, a workflow software development kit (SDK) 32, a workflow platform 20, and an authentication service 46. In embodiments, the workflow SDK 32 is installed on the computing device 30. As described above, the workflow platform 20 may integrate an API implemented by the authentication service 46 to facilitate communication between the workflow platform 20 and the authentication service 46.

A user may use the computing device 30 to start an account opening process. For example, the user may use the computing device 30 to open an account in a mobile application associated with a resource (e.g., a banking application). When the user initiates the account opening process, the mobile application calls the workflow SDK 32 to start a corresponding account opening workflow, such as the workflow 620 described above.

User data is captured by the computing device 30. In an example, the data captured by the computing device include profile data (e.g., a user identifier, a name, and contact information) and biometric data (e.g., an image of the user's face). In embodiments, the profile data may be used to open an account for the user, and the biometric data may be used when registering an authenticator for the user. In the illustrated example, the workflow SDK 32 uses the biometric data to create a biometric token, which is stored on the computing device 30. As described herein, the biometric token may be registered with the authentication service 46 to authenticate the user.

After creating and storing the biometric token the workflow SDK 32 may trigger the workflow platform 20 to start the account and authenticator registration process. In an example, the workflow SDK 32 may transmit the user profile data to the workflow platform 20. A token associated with the computing device 30 and a workflow identifier may also be transmitted to the workflow platform 20. The workflow platform 20 may transmit the profile data to the authentication service 46 to create an account for the user. The authentication service 46 may return a unique user identifier to the workflow platform 20, which may be used by the workflow platform 20 to identify the user's account during future interactions with the authentication service 46.

The workflow platform 20 may also have the authentication service 46 register an authenticator for the user. In an example, the workflow platform 20 may transmit the unique user identifier, the token associated with the computing device 30, and the workflow identifier to the authentication service, and the authentication service 46 creates an authentication entity. In an embodiment, the authentication entity created by the authentication service 46 includes the unique user identifier, the workflow identifier, an expiry, the device token, a serial number, an authentication token, and a status.

After creating the authentication entity, the authentication service 46 sends a silent push notification to the computing device 30 to create an identity. In an embodiment, the notification includes a link to the authentication service 46, the serial number, the status, the authentication token, and the workflow identifier. The computing device 30 may use the information from the notification to create and store the identity. The identity created by the computing device 30 may additionally include an identifier of the biometric token.

The computing device 30 synchronizes with the authentication service 46 after creating the identity. Synchronizing with the authentication service 46 may include transmitting the identifier of the biometric token to the authentication service 46. The authentication service 46 can then inform the workflow platform 20 that the authentication entity has been created.

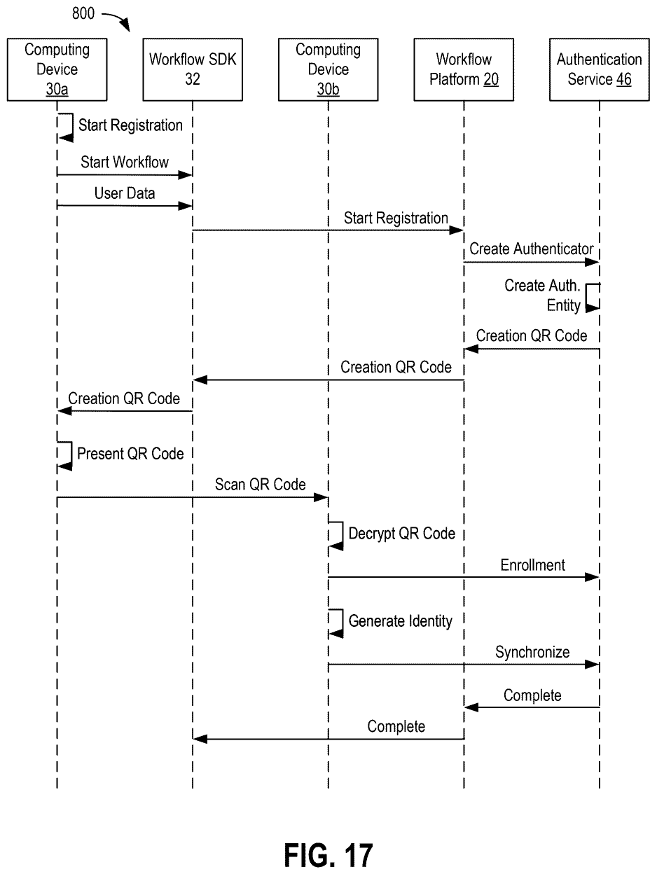

FIG. 17 illustrates another example message flow diagram 800 for registering an authenticator with an authentication service. In contrast to the message flow diagram 700 described above, in the message flow diagram 800 shown in FIG. 17, the user may use a web application and a mobile application when enrolling the authenticator. Accordingly, the illustrated message flow diagram 800 shows communications between a first computing device 30a (which executes the web application), a second computing device 30b (which executes the mobile application), a workflow SDK 32, a workflow platform 20, and an authentication service 46. While the illustrated embodiment includes a first computing device 30a executing the web application and the second computing device 30b executing the mobile application, in alternative embodiments, a single computing device may execute both the web application and the mobile application. The workflow SDK 32 may be installed on one or both of the computing devices 30.

At the first computing device 30a, the user starts the process to register an authenticator. The workflow SDK 32 is triggered to start an authenticator registration workflow and collects data form the user. In an example, the user data collected includes profile data and biometric data.

The workflow SDK 32 calls the workflow platform 20 to trigger authenticator creation. In an embodiment, a workflow identifier and a user identifier are transmitted to the workflow platform 20. The workflow platform 20 may forward the workflow identifier and the user identifier to the authentication service 46 to cause the authentication service to create an authenticator entity.

The authentication service 46 creates the authenticator entity and transmits a machine-readable code (e.g., a QR code) back to the first computing device 30a through the workflow platform 20 and the workflow SDK 32. In an embodiment, the machine-readable code encodes a serial number, a link to the authentication service 46 for registration of the authenticator, and a registration password.

The first computing device 30a presents the machine-readable code which is scanned by the second computing device 30b. The second computing device 30b decrypts the machine-readable code to determine the serial number, the link to the authentication service 46 for registration of the authenticator, and the registration password.

Using the link to the authentication service 46, the second computing device 30b triggers an enrollment process. In an embodiment, the second computing device 30b transmits the serial number and the registration password to the authentication service to start the enrollment process.

After the enrollment process, the second computing device 30b generates an identity. In an example, the identity generated by the second computing device 30b includes a link to the authentication service, the serial number, a status, an expiry, an authentication token, and an identifier of a biometric token stored on the second computing device 30b. The second computing device 30b can then synchronize with the authentication service 46 to complete registration of the authentication. In an example, to synchronize with the authentication service 46, the second computing device 30b transmits the identifier of the biometric token and the serial number to the authentication service 46.

While the illustrated examples describe registering biometric authenticators, in alternative examples, other authenticators may be registered with the authentication service 46. For example, soft token and passkey authenticators may additionally or alternatively be registered with the authentication service 46.

FIGS. 18-21 illustrate using an integrated authentication service to authenticate a user. FIGS. 18-20 illustrate an example workflow generation user interface 910 for generating a workflow 920 including tasks 922 to authenticate a user. The tasks 922 in the workflow may be represented the workflow generation user interface 910 by task elements (i.e., graphical representations) associated with the tasks 922. In the illustrated examples, the workflow generation user interface 910 is presented within a workflow application 200. In some embodiments, the workflow application may execute on a computing device, such as the computing device 30 described above in connection with FIGS. 1 and 2. In other embodiments, the workflow generation user interface 910 may be presented in browser executing on a computing device connected to a workflow platform, such as the computing device 30 connected to the workflow platform 20 described above.

FIG. 18 illustrates an example workflow 920 for authenticating a user with an authentication service. In the illustrated example, the workflow 920 includes a plurality of workflow tasks 922, including a user authentication task 922a. As described above, the workflow 920 may include some tasks 922 that are performed by workflow services of a workflow platform and some tasks 922 that are performed, at least in part, by integrated services. As described above, the integrated services may be external services or services included within the workflow platform. In this example, the user authentication task 922a may be performed, at least in part, by an integrated authentication service.

In the illustrated example, the workflow 920 may be a diverging workflow in which the user authentication task 922a may lead to three result tasks 922b-d depending on a risk level output by the user authentication task 922a. For example, a risk score may be calculated as a percentage, with a higher percentage indicating a higher risk. The risk score may be compared to defined risk thresholds to determine the risk level. In examples factors that may be considered when calculating the risk score include date, time, geolocation, travel velocity, location history, transaction risk, or external risk. In some examples, weights may be applied to the risk factors. During configuration of the workflow 920, the risk factors and weights applied during the user authentication task 922a may be defined by a user. In other examples, the risk factors and weights may be determined automatically. For example, the risk factors and weights may be based on a policy or template selected by the user. In embodiments, creating a diverging workflow 920 based on risk determined when authentication a user, appropriate verification measures (i.e., the tasks 922b-d) can be applied during execution of the workflow 920.

In some embodiments, when the workflow 920 is finalized and saved by the user, an OpenID (OIDC) application may be created and associated with the workflow 920. In an example, the OIDC application associated with the workflow 920 may allow user interfaces associated with the workflow platform to be used when the workflow 920 is executed and a user is authenticated.

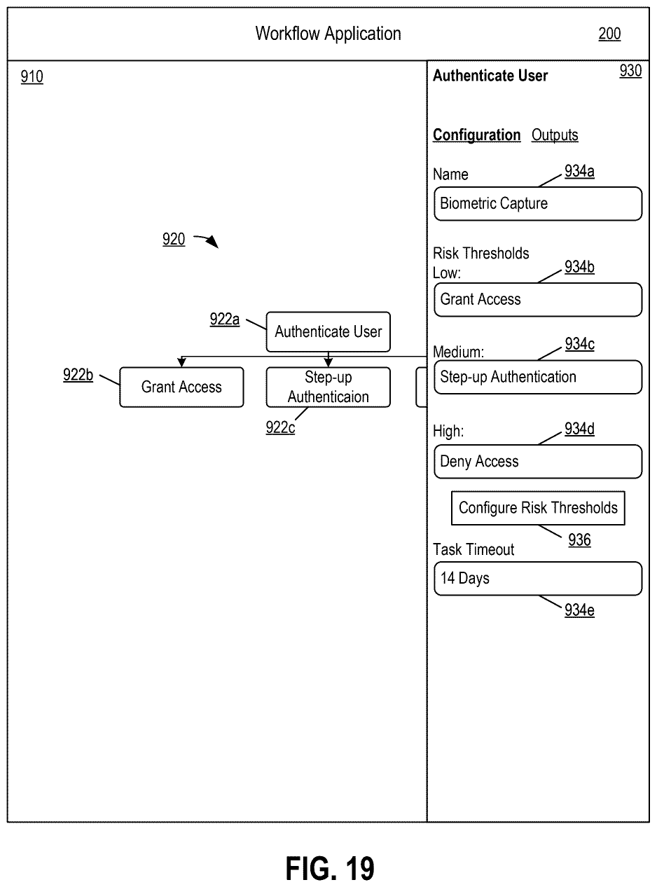

FIG. 19 illustrates an example task configuration interface 930 presented in the workflow generation user interface 910. In the illustrated example, the task configuration interface 930 can be used to configure the user authentication task 922a described above. In the illustrated example, the task configuration interface 930 includes options to define a name of the task and a timeout period for the task. The user may use inputs 934a, 934e to change values for these options.

The task configuration interface 930 may also include options to change risk thresholds of the user authentication task 922a. For example, in the illustrated embodiment, the task configuration interface 930 may include inputs 934b-d to configure the result of the authentication based on a risk level. In the illustrated example, when the risk level is low, the user may be granted access to a resource, as indicated by the input 934b. When the risk level is medium, the user may be required to perform step-up authentication, as indicated by the input 934c. When the risk level is high, the user may be denied access to the resource, as indicated by the input 934d. The task configuration interface 930 may also include an option 936 to configure the risk thresholds.

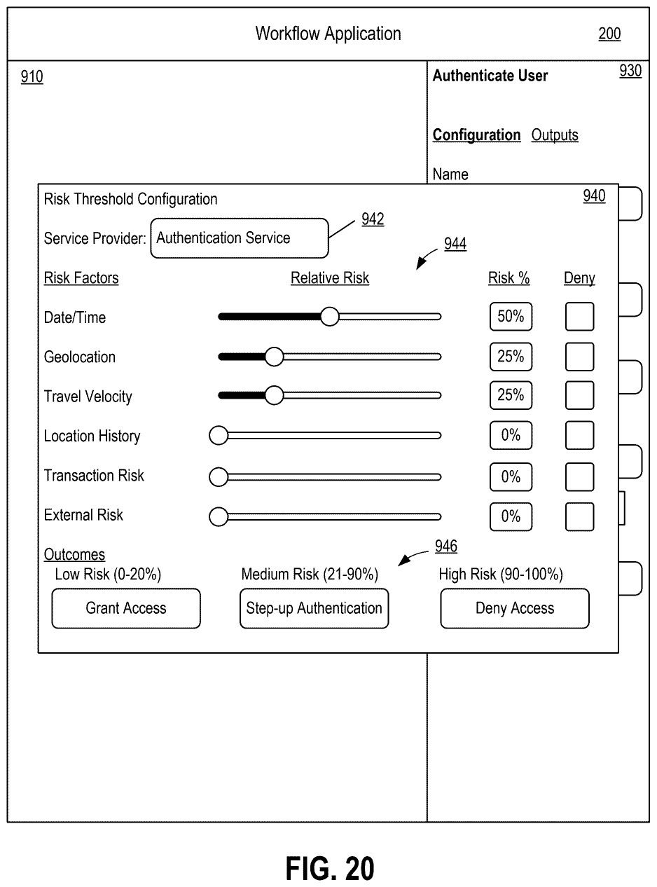

FIG. 20 illustrates an example risk threshold configuration interface 940. In embodiments, the risk threshold configuration interface 940 may include options for a user to adjust how the risk score is determined and the outcomes of the authentication. In the illustrated example, the risk threshold configuration interface 940 also includes an input 942 to define what authentication service is used when performing the authentication.

The risk threshold configuration interface 940 may include inputs 944 to adjust the risk factors considered when authenticating the user. For example, in the illustrated example, the inputs 944 may allow the user to adjust a relative risk associated with a plurality of risk factors including a date and time, a geolocation, a travel velocity, a location history, a transaction risk, and an external risk.

The risk threshold configuration interface 940 may also include inputs 946 to define what steps are taken based on the calculated risk score. As described above, in this example, the outcomes may include to grant access, require step-up authentication, and deny access for low, medium, and high risk scores, respectively.

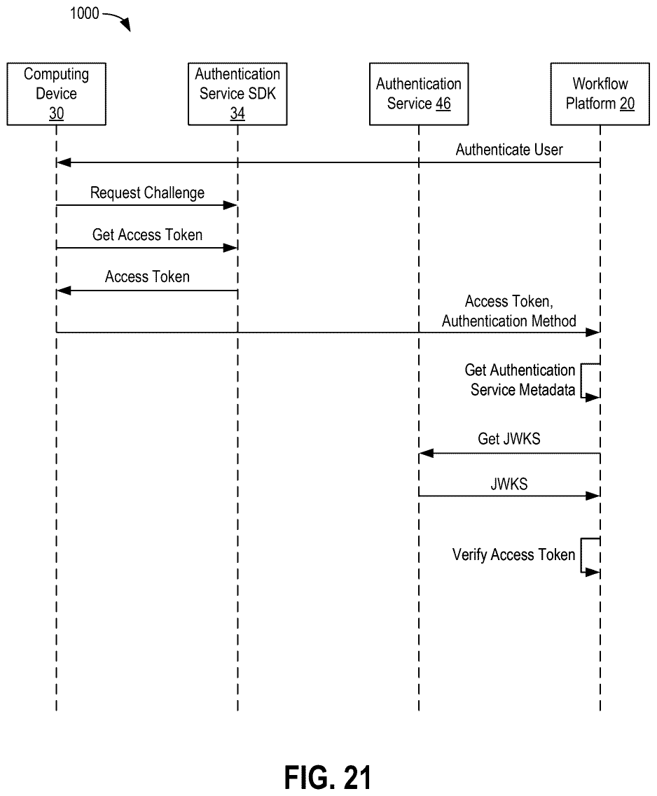

FIG. 21 illustrates a message flow diagram 1000 for authenticating users with an authentication service. In the illustrated example, the message flow diagram 1000 shows communications between a computing device 30, an authentication service SDK 34, an authentication service 46, and a workflow platform 20. In embodiments, the authentication service SDK 34 is installed on the computing device 30. As described above, the workflow platform 20 may integrate an API implemented by the authentication service 46 to facilitate communication between the workflow platform 20 and the authentication service 46.

During execution of a workflow, the workflow may progress to a task in which a user must be authenticated, such as the user authentication task 922a described above. At this step in the workflow platform 20 instructs the computing device to begin authentication of the user. The computing device 30 may request a challenge and an access token from the authentication service SDK 34 to begin authentication of the user.

The authentication token is sent from the computing device 30 to the workflow platform 20 for authentication. In some embodiments, the computing device 30 may also send an SDK token associated with the authentication service SDK 34 and an authentication method to the workflow platform 20.

The workflow platform 20 identifies metadata associated with the authentication service 46. In an embodiment, the metadata includes a hostname. Using the hostname, the workflow platform 20 may retrieve keys from the authentication service 46 for verifying the access token. In an example, the keys include a JSON web key set (JWKS). The workflow platform 20 can then verify the authentication token using the retrieved keys to authenticate the user.

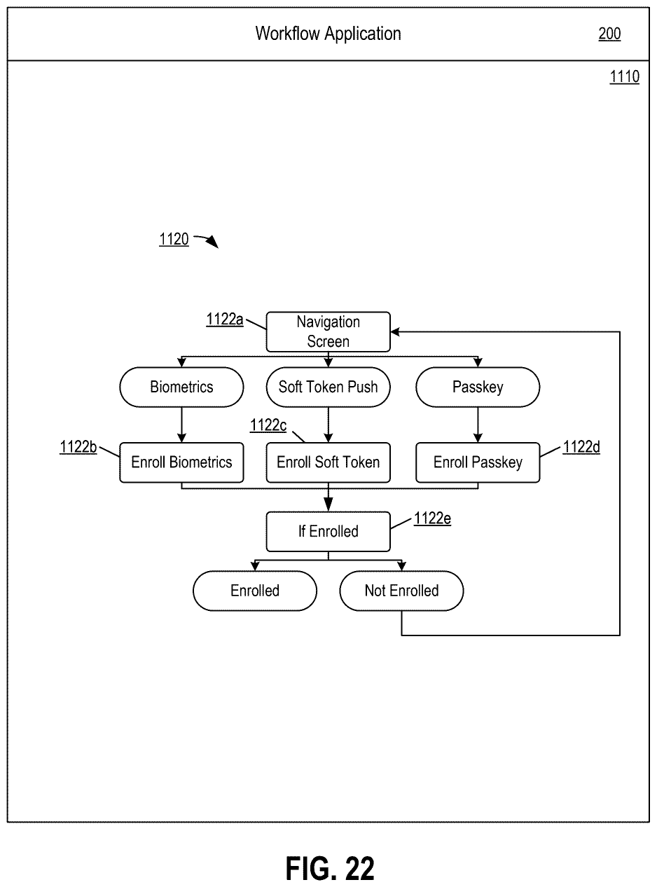

FIGS. 22-24 illustrate an example of a diverging workflow—i.e., a workflow in which a task may lead to two or more alternative tasks. A diverging workflow may allow a user to create a single workflow that handles multiple use cases that may be dependent on user behavior or task results during execution of the workflow. For example, a workflow may include multiple alternative identity verification tasks, with each of the identity verification tasks associated with a risk score of a user determined during a risk assessment task—e.g., a high risk score may cause a higher security identity verification task to be performed. Because the risk score is not known until execution of the workflow, by creating a diverging workflow, a single workflow can be created that covers each potential use case, rather than requiring the user to create separate workflows for each case. Similarly, creating a diverging workflow allows for tasks on each of the branching paths to inherit attributes from tasks that are executed before the workflow branches into alternative paths.

Additionally, the diverging workflow allows for additional paths in the workflow as new types of tasks are added or security concerns are identified. For example, if a new security concern is identified, a new diverging path can be added to the workflow to specifically target the security concern. This allows the security concern to be addressed quickly and does not require a user to create a whole new workflow each time an update to the workflow is needed.

FIG. 22 illustrates an example workflow generation user interface 1110 for generating a diverging workflow 1120. In the illustrated example, the workflow 1120 may be used to enroll an authenticator for a user; however, in other examples, a diverging workflow may be used in other cases as well, such as for identity verification, authentication, or digital document signing. The tasks 1122 in the workflow may be represented the workflow generation user interface 1110 by task elements (i.e., graphical representations) associated with the tasks 1122.

In the illustrated example, the workflow 1120 may begin with a navigation task 1122a. In an example, the navigation task 1122a may include presenting a navigation screen to a user. In the illustrated example, as described further herein, the navigation screen may include options for a user to select a type of authenticator to be enrolled. For example, the navigation screen may include options for the user to enroll a biometric authenticator, a soft token authenticator, or a passkey authenticator.

Depending on the selection made by the user on the navigation screen, the workflow 1120 may progress to one of three enrollment tasks 1122b-d. For example, if the user selects to enroll a biometric authenticator, the workflow 1120 may proceed to a biometric authenticator enrollment task 1122b. If the user selects to enroll a soft token authenticator, the workflow 1120 may proceed to a soft token authenticator enrollment task 1122c. If the user selects to enroll a passkey authenticator, the workflow 1120 may proceed to a passkey authenticator enrollment task 1122d.

The workflow 1120 may converge at an enrollment checking task 1122e that confirms that the authenticator was properly enrolled. If the authenticator was not properly enrolled, the workflow 1120 may return to the navigation task 1122a. If the authenticator was properly enrolled, the workflow 1120 may end in completion or proceed to additional tasks (not illustrated).

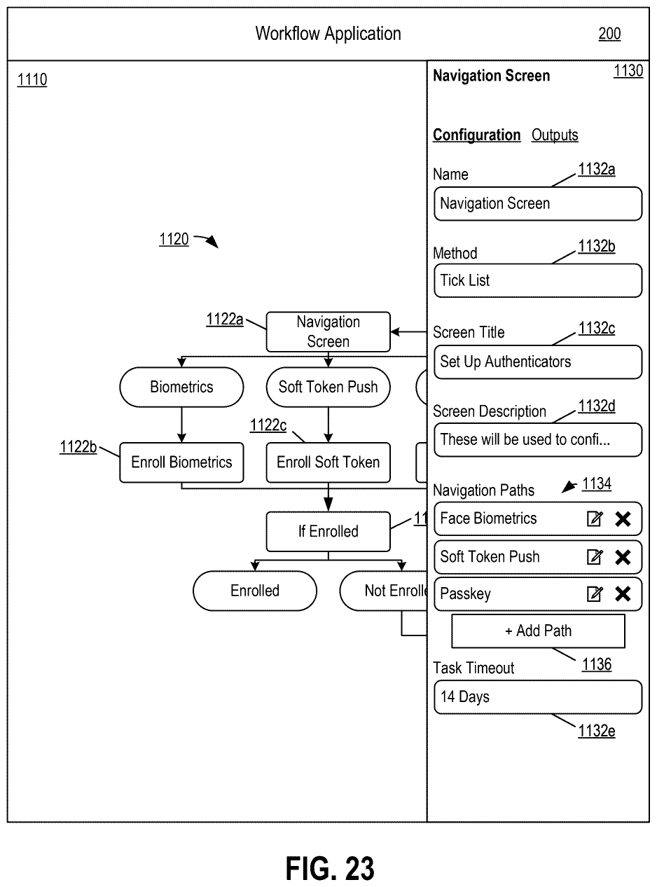

FIG. 23 illustrates an example task configuration interface 1130 presented in the workflow generation user interface 1110. In the illustrated example, the task configuration interface 1130 can be used to configure a task that leads to diverging paths in the workflow 1120—e.g., the navigation task 1122a. In the illustrated example, the task configuration interface 1130 includes an input 1132a to define a name of the navigation task 1122a, an input 1132b to define an input method for a user to select navigation paths on the navigation screen, an input 1132c to define a title that is presented on the navigation screen, an input 1132d to define a description presented on the navigation screen, and an input 1132e to define a timeout period for the navigation task 1122a.

The task configuration interface 1130 may also include a list 1134 of possible paths diverging from the navigation task 1122a. In the illustrated example, the paths include a biometrics path, a soft token path, and a passkey path. Each path in the list 1134 may include options to edit or delete the path. The task configuration interface 1130 may also include an option 1136 to add a path.

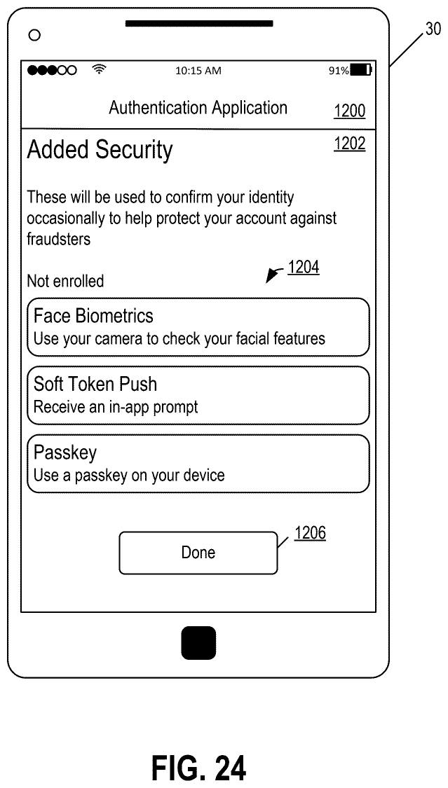

FIG. 24 illustrates an example navigation screen that may be presented during execution of the workflow 1120 described above in connection with FIGS. 22 and 23. In the illustrated example, a navigation user interface 1202 is presented in an authentication application 1200 executing on a computing device 30. In an example, the navigation user interface 1202 may be presented to a user registering an authenticator.

As described above, during generation of an associated workflow, elements of the navigation user interface 1202 may be defined by a configuration of a navigation task (e.g., the navigation task 1122a described above). For example, a title and description presented on the navigation user interface 1202 may be defined by the navigation task. In the illustrated example, the navigation user interface 1202 includes options 1204 for a user to select a type of authenticator to register—biometrics, soft token, and passkey in the illustrated example. The options 1204 may also be defined by the navigation task, as described above. After selecting an option 1204, the user may select an option 1206 to proceed with registration of the selected authenticator. As described above, depending on the option 1204 selected by the user, the workflow executing to register the authenticator for the user may proceed to different tasks based on the selection.

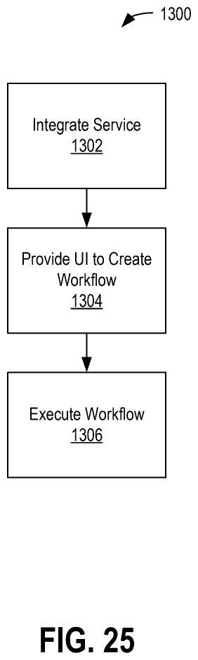

FIG. 25 illustrates a flowchart of an example method 1300 for creating and executing a workflow. In the illustrated example, the method 1300 includes operations 1302, 1304, 1306. In embodiments, the method 1300 may be performed by a workflow platform in conjunction with one or more integrated services, such as the workflow platform 20 and the integrated services 40 described above in connection with FIGS. 1 and 2.

The operation 1302 includes to integrate a service with a workflow platform. In an example, integrating the service with the workflow platform includes integrating an API implemented by the service, allowing the workflow platform to communicate with the integrated service. In examples, the integrated service may include one or more of a risk assessment service, a document signature service, and an authentication service. In some embodiments, the integrated service may be configured to perform operations that the workflow platform is not configured to perform. For example, the workflow platform may be an identity verification server and may not be configured to perform operations related to risk assessment, document signature, and authentication. By integrating the service with the workflow platform, the workflow platform can use resources of the integrated service during execution of a workflow.

The operation 1304 includes providing a user interface to create a workflow. In an example, a workflow generation user interface may be presented to a user that allows the user to build a workflow in a drag-and-drop manner. In some embodiments, the workflow generated through the workflow generation user interface may include a plurality of workflow tasks. As described above, some of the workflow tasks may be tasks that, during execution of the workflow, are performed by workflow services at the workflow platform while other tasks may be performed, at least in part, by an integrated service. By allowing the user to create the workflow including tasks that may be performed using the integrated services in addition to the tasks that may be performed by the workflow platform, the user is able to create a workflow that perform tasks associated with a variety of operations through a single interface—rather than the user needing to create separate workflows with each service based on the operations needed by the user.

The drag-and-drop architecture described herein allows users to visually construct and configure workflows without writing code. Each workflow task (e.g., ID capture, risk scoring, or signature collection) is represented as a modular, configurable element that can be placed and sequenced within a graphical interface. The temporal order of tasks is inferred from their spatial arrangement, and attribute dependencies between tasks are automatically resolved based on predefined relationships and user-defined linkages.

The operation 1306 includes executing the workflow created by the user. In an example, the workflow is executed by the workflow platform in conjunction with the integrated services. For example, if the workflow includes a risk assessment task, the workflow platform may work in conjunction with a risk assessment service to complete the risk assessment task—e.g., the workflow platform may use the risk assessment service to calculate a risk score, and the workflow platform may execute different tasks based on the calculated risk score. In other examples, as described above, the workflow platform may additionally or alternatively execute the workflow in conjunction with a document signature service or an authentication service.

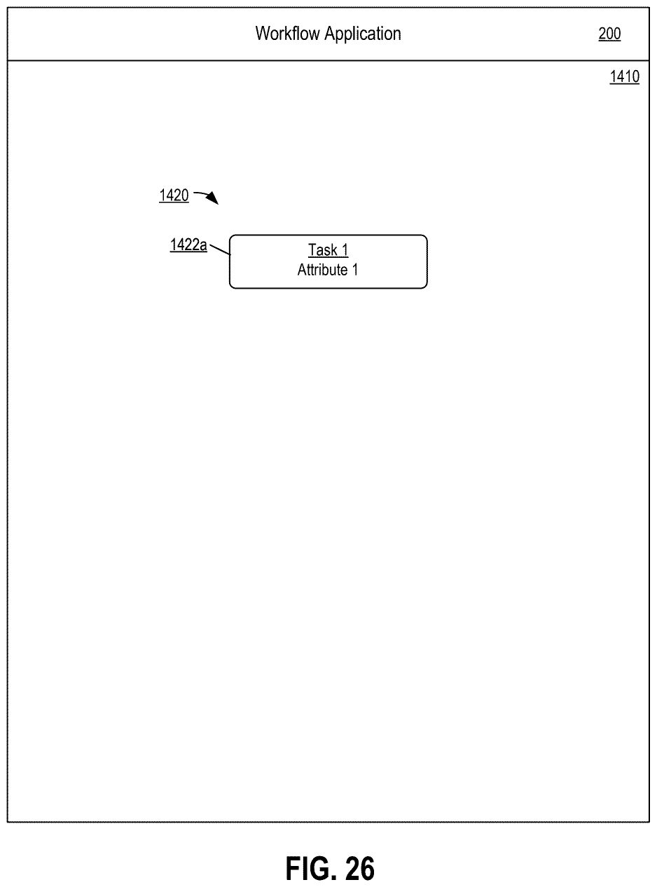

FIGS. 26-32 illustrate an example of dynamically generating a workflow. As with the examples described above, a workflow 1420 may be generated through a workflow generation user interface 1410 in a workflow application 200. In examples, the workflow application 200 executes on a computing device, such as the computing device 30 described above in connection with FIGS. 1 and 2.

FIG. 26 illustrates a first step of a user creating the workflow 1420. In the illustrated example, the user may begin creation of the workflow 1420 by adding a first task 1422a to the workflow 1420. In an embodiment, the user may add the first task 1422a to the workflow 1420 by dragging a task element (i.e., a graphical representation) associated with the first task 1422a into the workflow generation user interface 1410. In alternative embodiments, the user may begin creation of the workflow 1420 by selecting a template of the workflow 1420. The user may then choose to edit the workflow 1420, such as by adding tasks 1422, removing tasks 1422, or changing attributes of tasks 1422.

As described above, the first task 1422a may include one or more attributes, such as inputs, outputs, and configurations. In alternative embodiments, the attributes may include additional or alternative features. In the illustrated example, the attributes may be shown within the task elements for the tasks 1422 in the workflow 1420. As described above, in other examples, the attributes of tasks 1422 may additionally or alternatively be shown in tasks configuration interfaces.

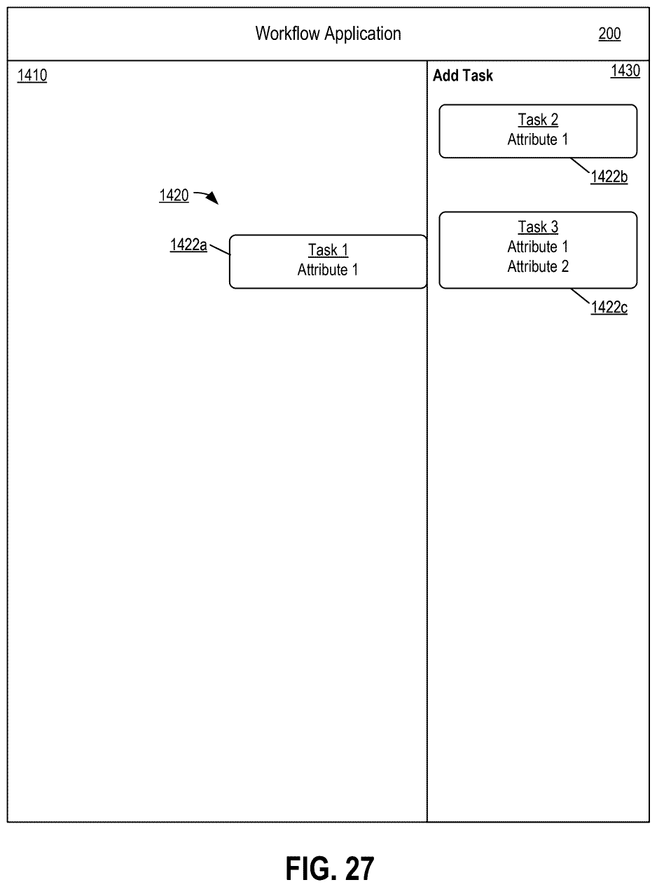

FIG. 27 illustrates a second step of the user creating the workflow 1420. In the illustrated example, the user may choose to add a task 1422 to the workflow 1420. In embodiments, the user may select a task to add to the workflow 1420 through a task selection interface 1430 from which the user may select a task 1422 to add to the workflow 1420. In embodiments, the task selection interface 1430 may include a plurality of tasks 1422 from which the user can select. In embodiments, the task selection interface 1430 may include options to filter or search for specific tasks 1422 or types of tasks 1422. For example, the user may use a filter so that the task selection interface 1430 presents identity verification tasks.

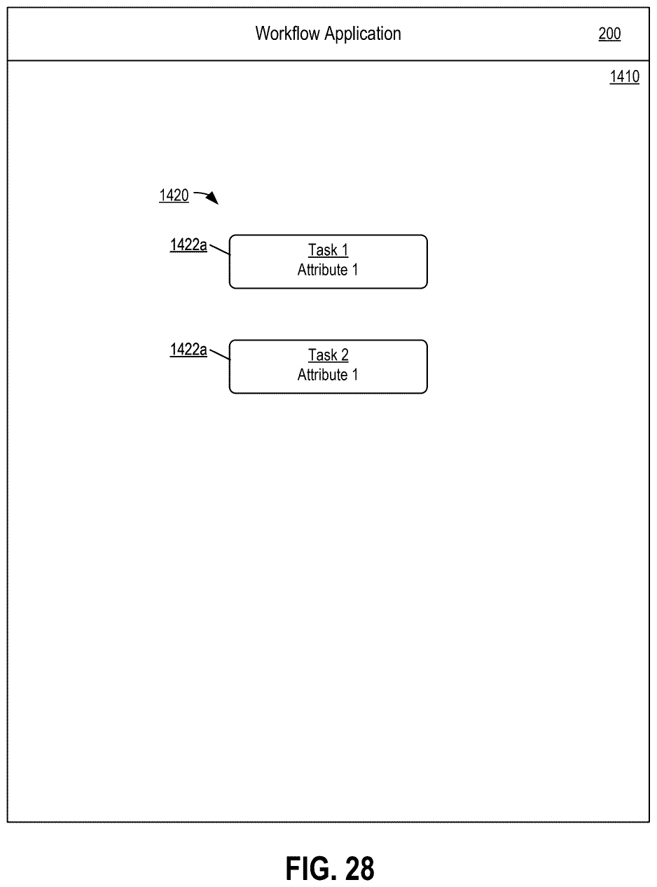

After determining which task 1422 to add to the workflow 1420, the user may add the task 1422 to the workflow 1420 by dragging the task 1422 into the workflow generation user interface 1410. FIG. 28 illustrates a third step of the user creating the workflow 1420. In the illustrated example, the user may select to add a second task 1422b to the workflow 1420. Accordingly, the user may drag the second task 1422b from the task selection interface 1430 described above into the workflow generation user interface 1410. In an example, the user may desire for the second task 1422b to be performed after the first task 1422a during execution of the workflow 1420. Accordingly, the user may arrange the tasks 1422 within the workflow generation user interface 1410 such that the first task 1422a is arranged vertically above the second task 1422b. In embodiments, the arrangement of the tasks 1422 may indicate a temporal order of the tasks 1422.

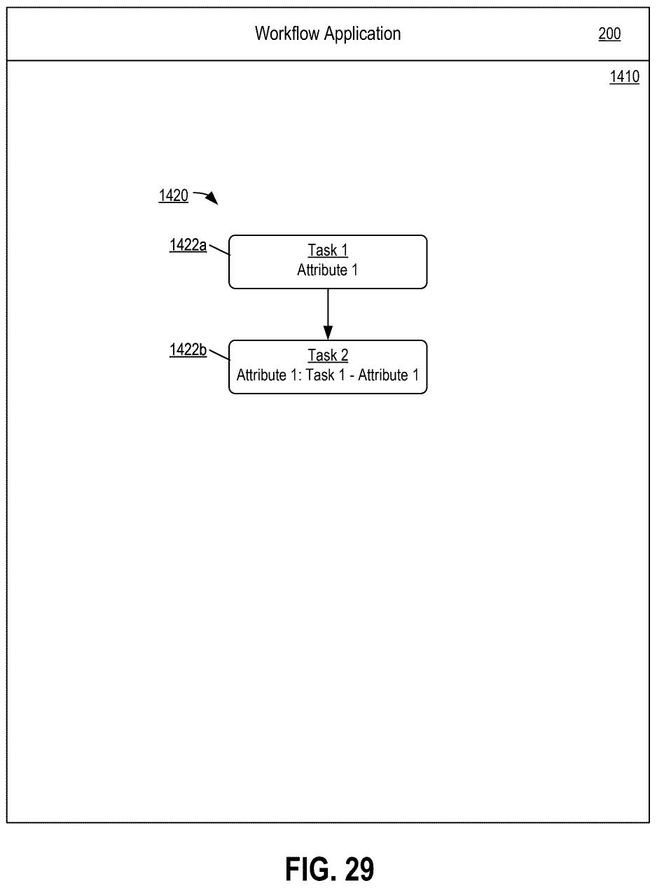

FIG. 29 illustrates a fourth step of the user creating the workflow 1420. As described above, the arrangement of tasks 1422 may indicate a temporal order of the tasks 1422. In the illustrated example, because the second task 1422b is arranged below the first task 1422a, the second task 1422b may be performed after the first task 1422a. Accordingly, an arrow from the first task 1422a to the second task 1422b may automatically be presented in the workflow generation user interface 1410 based on the arrangement of the tasks 1422 to indicate the temporal order of the tasks 1422. While the illustrated example shows a vertical arrangement of the tasks 1422 indicating the temporal order of the tasks 1422, in alternative examples, other arrangements of the tasks 1422 may indicate the temporal order of the tasks 1422. For example, a horizontal arrangement of tasks 1422 may indicate the temporal order of the tasks 1422, with tasks 1422 located on the left side of the workflow generation user interface 1410 being performed before tasks 1422 located on the right side of the workflow generation user interface 1410. Additionally, in some embodiments, the user may manually draw the arrow between tasks 1422 to create the temporal order between tasks 1422.

Additionally, dependencies between tasks 1422 may automatically be determined. For example, the dependencies may be determined based on the temporal order of the tasks and a set of relationships between attributes. In the illustrated example, both the first task 1422a and the second task 1422b include a first attribute. In an example, the first attribute may be a name of a user that is needed for performance of both tasks. For example, the first task 1422a may be an identity verification task that uses the name of the user to verify the user's identity, and the second task 1422b may be a document signature task that uses the name of the user to prepare a document for the user to sign. To reduce the amount of data that must be input by the user during execution of the workflow 1420, the attributes of the tasks may be linked so that the second task 1422b inherits the data associated with the first attribute from the first task 1422a, allowing the second task 1422b to be performed without requiring the user to input the data multiple times.

Because the first attribute is related for the first task 1422a and the second task 1422b and the temporal order of tasks 1422 indicates that the second task 1422b is performed after the first task 1422a during execution of the workflow 1420, a dependency may automatically be created between the first attribute of the second task 1422b and the first attribute of the first task 1422a. The dependency between the attributes may be shown by listing the task 1422 and the attribute to which the attribute is dependent, as shown in the second task 1422b in the illustrated example.

In alternative embodiments, the dependencies between tasks 1422 may be manually created by the user. For example, the user may specify that the first attribute for the second task 1422b is inherited from the first attribute of the first task 1422a, manually creating the dependency. In embodiments, as described above, the user may use a task configuration interface to define the attributes of a task 1422, and dependencies maybe created based on the definition of attributes defined by the user.

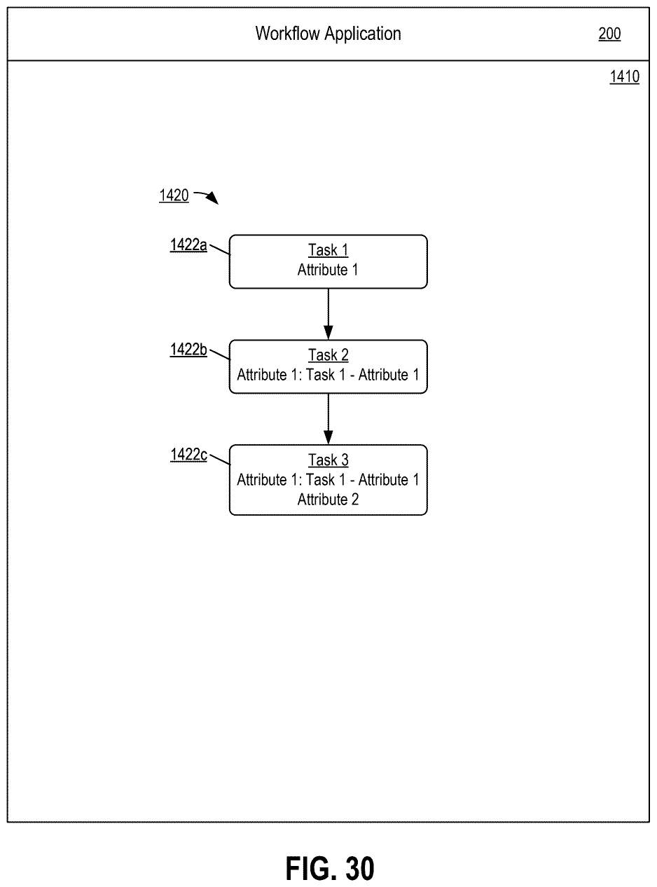

FIG. 30 illustrates a fifth step of the user creating the workflow 1420. In the illustrated example, the user may add a third task 1422c to the workflow 1420. In embodiments, as the user adds tasks 1422 to the workflow 1420, and as the user continues to arrange the tasks 1422 in the workflow 1420, the temporal order of the tasks 1422 may be updated. Additionally, in some embodiments, the dependencies of attributes of tasks 1422 may automatically be updated as the user makes changes to the workflow 1420—e.g., by adding tasks 1422 or rearranging the order of tasks 1422. In the illustrated example, the third task 1422c has an attribute related to the attributes of the first task 1422a. Accordingly, a dependency may be created (either automatically or manually by the user) to link the first attribute of the third task 1422c to the first attribute of the first task 1422a. The third task 1422c may also include a second attribute. Based on the temporal order of the tasks 1422 and the set of relationships between attributes, a dependency may not be created for the second attribute of the third task 1422c. Accordingly, the user may manually define the second attribute of the third task 1422c.

While the illustrated example shows the additional of a third task 1422c, in further examples, additional tasks 1422 may be added to the workflow 1420. Similarly, as the user creates the workflow 1420, the user may remove tasks 1422 from the workflow 1420. Additionally, while the illustrated example shows a workflow 1420 with a linear path, in other examples, the user may create a diverging workflow that includes multiple alternative paths, as described above.

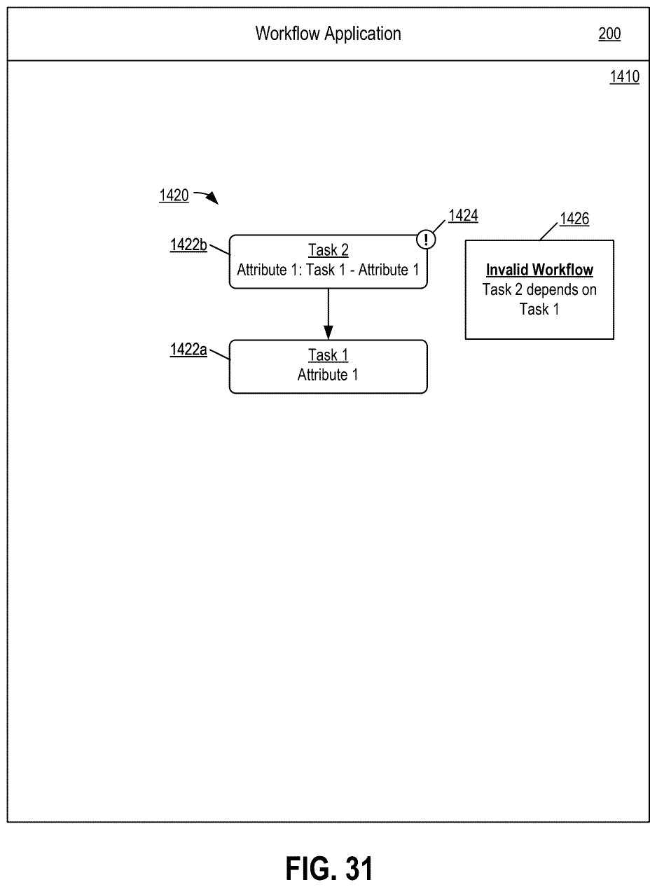

FIG. 31 illustrates an example of an invalid workflow 1420. In an embodiment, a validity of the workflow 1420 may be determined based on the dependencies and the temporal order of the tasks 1422. For example, in the illustrated example, the workflow 1420 may be invalid because the second task 1422b includes an attribute that is dependent on an attribute of the first task 1422a, but the temporal order of the tasks 1422 indicates that the second task 1422b is performed before the first task 1422a. Accordingly, the workflow 1420 may be invalid because the second task 1422b cannot properly inherit the data for the first attribute from the first task 1422a as the first task 1422a is not performed before the second task 1422b. A task warning element 1424 may be presented on the second task 1422b to indicate that an issue with the second task 1422b is making the workflow 1402 invalid. Additionally or alternatively, a validity warning element 1426 may be presented to inform the user that the workflow 1420 is not valid. For example, the validity warning element 1426 may describe why the workflow 1420 is invalid.

In other examples, validity of the workflow 1420 may be determined based on additional or alternative factors. For example, the workflow 1420 may be invalid if an attribute of a task 1422 is not defined—e.g., an input of the task 1422 is not defined. Similarly, the workflow 1420 may be invalid if the temporal order of the tasks 1422 creates an infinite loop—e.g., the first task 1422a leads to the second task 1422b which leads back to the first task 1422a.

In some embodiments, compliance of the workflow 1420 with an identified compliance standard or policy may additionally or alternatively be verified. Examples of verifying compliance of the workflow 1420 with an identified compliance standard or policy are described in U.S. Provisional Patent Application No. 63/720,420 titled “Identity Verification Workflow Compliance Management,” which is incorporated by reference in its entirety herein.

In embodiments, for the workflow 1420 to be generated, the workflow 1420 may need to be both valid and compliant. In alternative embodiments, the workflow 1420 may be generated if the workflow 1420 is valid, even if the workflow 1420 is not compliant.

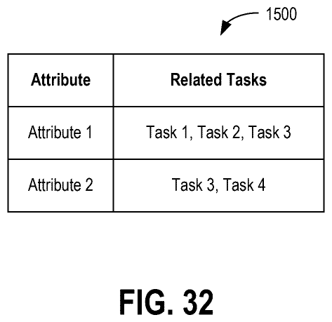

FIG. 32 illustrates an example set 1500 of relationships between task attributes. In an example, the set 1500 of relationships may be maintained by the workflow platform. As described above, the set 1500 of relationships between task attributes may be used to determine dependencies between task attributes. In the illustrated example, the set 1500 of relationships includes a mapping of attributes to tasks for which the attributes are related. For example, in the illustrated embodiment, a first attribute may be related for a first task, a second task, and a third task. In an example, the first attribute may be a user name. Because the user name may be data used by each of the first task, the second task, and the third task, the attribute may be related for these tasks. Similarly, in the illustrated example, a second attribute may be related for the third task and a fourth task. For example, the second attribute may be a risk score. The risk score may be generated by the third task and used by the fourth task to determine which of a plurality of diverging pathways to follow. In other examples, the set 1500 of relationships may define relationships between additional or alternative attributes for additional or alternative tasks.

As described above, the set 1500 of relationships may be used to determine dependencies of task attributes. For example, if the first task and the second task are included in a workflow, a dependency may be created between the first attribute of the first task and the first attribute of the second task. The dependency may be dependent on a temporal order of the tasks. For example, if the first task is arranged before the second task, a dependency may be created such that the second task depends on the first task. Similarly, if the second task is arranged before the first task, a dependency may be created such that the first task depends on the second task.

In some examples, the set 1500 of relationships may further define a specified order of tasks. For example, the second attribute may be an output of the third task and an input of the fourth task. Accordingly, the set 1500 of relationships may define that the fourth task is always dependent on the third task, regardless of the arrangement of the tasks during generation of the workflow.

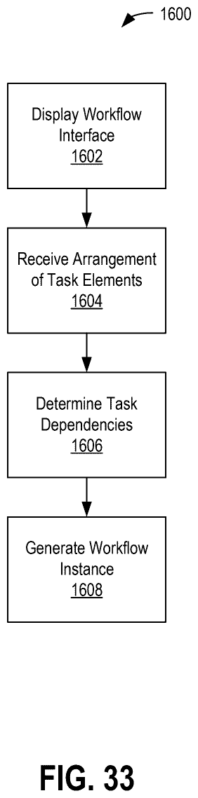

FIG. 33 illustrates a flowchart of an example method 1600 for generating a workflow. For example, the method 1600 may be used to generate a dynamic identity verification workflow. In the illustrated example, the method 1600 includes operations 1602, 1604, 1606, 1608. In an embodiment, the method 1600 is performed by a workflow platform, such as the workflow platform 20 and the integrated services 40 described above in connection with FIGS. 1 and 2.

The operation 1602 includes displaying a workflow interface. In embodiments, as described above, a user may use the workflow interface to create and configure a workflow. As described above, the user may use the workflow interface to create a workflow in a drag-and-drop manner, allowing the user to create the workflow without needing programing expertise. In an example, a workflow platform causes a computing device to present the workflow interface.

In an example, the workflow interface may present task elements (i.e., graphical representations) of a plurality of workflow tasks that have been added to the workflow. Each of the workflow tasks may include an action to be taken during execution of the workflow, such as by a client device, and a plurality of attributes defining the action, such as inputs, outputs, and a configuration of the task. As described above, the workflow tasks may include identity verification tasks, authentication tasks, risk assessment tasks, and digital signature tasks.

The operation 1604 includes receiving an arrangement of task elements within the workflow interface. In an example, the arrangement of task elements indicates a temporal order of the tasks within the workflow. For example, a first task may be arranged above a second task within the workflow interface, indicating that the first task is performed before the second task during execution of the workflow. Similarly, in an example, a first task and a second task may be arranged horizontally next to each other. In this example, this arrangement of the first task and the second task may indicate that the first task and the second task may be alternatives in a diverging workflow in which either the first task or the second task is performed during execution of the workflow.

In an embodiment, the user may arrange the task elements within the workflow interface on a computing device. The arrangement of task elements may then be transmitted from the computing device to a workflow platform.

The operation 1606 includes determining task dependencies. In embodiments, the task dependencies may be based on the temporal order of tasks—as indicated by the arrangement of task elements received during the operation 1604—and a set of relationships between attributes. The dependencies may indicate that a task depends on a previous task in the workflow. For example, an output for a first task may be used as an input for a second task. Accordingly, a dependency may be determined between attributes of tasks—e.g., the input of the second task and the output of the first task. In an example, the first task may include risk assessment, and the second task may include identity verification. A risk score output by the risk assessment task may determine a security level associated with the identity verification—e.g., a higher risk score may lead to a higher security level. In another example, the first task may include identity verification, and the second task may include authentication or signature capture. Identifying information that is collected during the identity verification task may be input into the authentication or signature capture task, reducing the need to recapture the identifying information.

The operation 1608 includes generating an instance of the workflow. In embodiments, the generated workflow instance is based on the determined task dependencies. The generated workflow instance may then be executed to perform the tasks included therein.

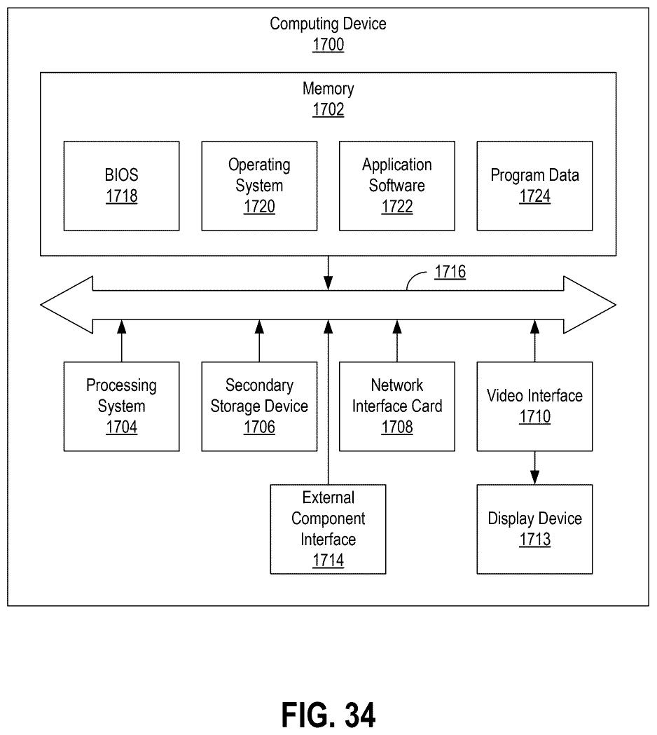

FIG. 34 illustrates an example computing device 1700 on which aspects of the present disclosure may be implemented. The computing device 1700 can be used, for example, to implement computing devices such as the computing device 30, the workflow platform 20, or any other computing device usable as described above in connection with FIGS. 1 and 2.

In the example of FIG. 34, the computing device 1700 includes a memory 1702, a processing system 1704, a secondary storage device 1706, a network interface card 1708, a video interface 1710, a display unit 1713, an external component interface 1714, and a communication medium 1716. The memory 1702 includes one or more computer storage media capable of storing data and/or instructions. In different embodiments, the memory 1702 is implemented in different ways. For example, the memory 1702 can be implemented using various types of computer storage media, and generally includes at least some tangible media. In some embodiments, the memory 1702 is implemented using entirely non-transitory media.

The processing system 1704 includes one or more processing units, or programmable circuits. A processing unit is a physical device or article of manufacture comprising one or more integrated circuits that selectively execute software instructions. In various embodiments, the processing system 1704 is implemented in various ways. For example, the processing system 1704 can be implemented as one or more physical or logical processing cores. In another example, the processing system 1704 can include one or more separate microprocessors. In yet another example embodiment, the processing system 1704 can include an application-specific integrated circuit (ASIC) that provides specific functionality. In yet another example, the processing system 1704 provides specific functionality by using an ASIC and by executing computer-executable instructions.

The secondary storage device 1706 includes one or more computer storage media. The secondary storage device 1706 stores data and software instructions not directly accessible by the processing system 1704. In other words, the processing system 1704 performs an I/O operation to retrieve data and/or software instructions from the secondary storage device 1706. In various embodiments, the secondary storage device 1706 includes various types of computer storage media. For example, the secondary storage device 1706 can include one or more magnetic disks, magnetic tape drives, optical discs, solid-state memory devices, and/or other types of tangible computer storage media.

The network interface card 1708 enables the computing device 1700 to send data to and receive data from a communication network. In different embodiments, the network interface card 1708 is implemented in different ways. For example, the network interface card 1708 can be implemented as an Ethernet interface, a fiber optic network interface, a wireless network interface (e.g., WiFi, WiMax, Bluetooth, etc.), or another type of network interface.

In optional embodiments where included in the computing device 1700, the video interface 1710 enables the computing device 1700 to output video information to the display unit 1713. The display unit 1713 can be various types of devices for displaying video information, such as an LCD display panel, a plasma screen display panel, a touch-sensitive display panel, an LED or OLED screen, a cathode-ray tube display, or a projector. The video interface 1710 can communicate with the display unit 1713 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 1714 enables the computing device 1700 to communicate with external devices. For example, the external component interface 1714 can be a USB interface and/or another type of interface that enables the computing device 1700 to communicate with external devices or peripheral devices integrated within the same housing (e.g., in the case of mobile devices). In various embodiments, the external component interface 1714 enables the computing device 1700 to communicate with various external components, such as external storage devices, input devices, speakers, modems, media player docks, other computing devices, scanners, digital cameras, and fingerprint readers.

The communication medium 1716 facilitates communication among the hardware components of the computing device 1700. The communication medium 1716 facilitates communication among the memory 1702, the processing system 1704, the secondary storage device 1706, the network interface card 1708, the video interface 1710, and the external component interface 1714. The communication medium 1716 can be implemented in various ways. For example, the communication medium 1716 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 1702 stores various types of data and/or software instructions. The memory 1702 stores a Basic Input/Output System (BIOS) 1718 and an operating system 1720. The BIOS 1718 includes a set of computer-executable instructions that, when executed by the processing system 1704, cause the computing device 1700 to boot up. The operating system 1720 includes a set of computer-executable instructions that, when executed by the processing system 1704, cause the computing device 1700 to provide an operating system that coordinates the activities and sharing of resources of the computing device 1700. Furthermore, the memory 1702 stores application software 1722. The application software 1722 includes computer-executable instructions, that when executed by the processing system 1704, cause the computing device 1700 to provide one or more applications. In an example, the memory 1702 stores application software 1722 for a workflow application. The memory 1702 also stores program data 1724. The program data 1724 is data used by programs that execute on the computing device 1700.

Although particular features are discussed herein as included within an electronic computing device 1700, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include various types of dynamic random access memory (DRAM), solid state memory, read-only memory (ROM), electrically-erasable programmable ROM, magnetic disks (e.g., hard disks, floppy disks, etc.), and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

It is noted that, in some embodiments of the computing device 1700 of FIG. 34, the computer-readable instructions are stored on devices that include non-transitory media. In particular embodiments, the computer-readable instructions are stored on entirely non-transitory media.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following examples.

The following is a non-exhaustive list of numbered examples which may or may not be claimed:

Example 1.1. A system for executing a workflow, the system comprising:
one or more processors; and one or more computer-readable storage devices storing data instructions that, when executed by the one or more processors, cause the system to:
   integrate a service with the system, wherein the service is configured to perform at least one operation that the system is not configured to perform;
   provide a user interface for configuring a workflow, the workflow including a plurality of workflow tasks; and
   execute the workflow, wherein a first workflow task is performed by the system and a second workflow task is performed, at least in part, by the integrated service.

Example 1.2. The system of Example 1.1, wherein to integrate the service with the workflow platform includes to integrate an application programming interface at the workflow platform, wherein the application programming interface is implemented by the service.

Example 1.3. The system of Example 1.1 or Example 1.2, wherein the service is a risk assessment service.

Example 1.4. The system of Example 1.3, wherein to execute the workflow includes to: receive an input defining user profile data, transmit the user profile data to the service, and receive from a risk score from the service.

Example 1.5. The system of Example 1.1 or Example 1.2, wherein the service is a document signature service.

Example 1.6. The system of Example 1.5, wherein to execute the workflow includes to receive a document for signature, transmit the document to the service, and receive a signed copy of the document from the service.

Example 1.7. The system of Example 1.1 or Example 1.2, wherein the service is an authentication service.

Example 1.8. The system of Example 1.7, wherein to execute the workflow includes to register an authenticator with the authentication service.

Example 1.9. The system of Example 1.7 or Example 1.8, wherein to execute the workflow includes to: authenticate a user with the authentication service.

Example 1.10.A non-transitory computer-readable medium having stored thereon data instructions that, when executed by one or more processors, cause the one or more processors to:
integrate a service with a workflow platform, wherein the service is configured to perform at least one operation that the workflow platform is not configured to perform;
provide a user interface for configuring a workflow, the workflow including a plurality of workflow tasks; and
execute the workflow, wherein a first workflow task is performed by the workflow platform and a second workflow task is performed, at least in part, by the integrated service.

Example 1.11.The computer-readable medium of Example 1.10, wherein the service is one of a risk assessment service, a document signature service, or an authentication service.

Examples 1.1-1.11 may provide the technical effects of integrating external services to perform operations not natively supported by the platform, allowing for end-to-end workflows that span multiple specialized capabilities. The integration (e.g., via service APIs) allows workflow tasks to be dynamically delegated to services such as risk assessment, document signing, or authentication, reducing system complexity while improving extensibility, interoperability, and automation. As a result, the system achieves more efficient, secure, and flexible workflow execution by offloading specialized processing while maintaining centralized configuration and state control through a unified user interface.

Example 2.1. A computer-implemented method for generating a dynamic identity verification workflow, the method comprising:
displaying, via a user interface, task elements of two or more tasks to include in a workflow process instance, wherein each task comprises an executable action to be taken by a client device and a plurality of attributes of the executable action;
receiving, via the user interface, an arrangement of the task elements, wherein the arrangement indicates a temporal order of a first task and a second task in the workflow process instance;
determining a dependency of an attribute associated with the second task to an attribute associated with the first task based on the temporal order and a set of relationships between attributes; and generating the workflow process instance based on the determined dependency.

Example 2.2. The computer-method of Example 2.1, wherein the first task is a risk assessment task and the second task is an identity verification task.

Example 2.3. The computer-method of Example 2.1, wherein the first task is an identity verification task and the second task is a signature capture task.

Example 2.4. The computer-method of Example 2.3, wherein the first task includes capturing identifying information, and wherein the dependency between the attribute of the second task and the attribute of the first task is based on identifying information captured during the first task.

Example 2.5. The computer-method of any of Examples 2.1-2.4, further comprising:
receiving, via the user interface, an addition of a task element associated with a third task; and
receiving, via the user interface, an updated arrangement of the task elements, wherein the updated arrangement indicates a temporal order of the first task, the second task, and the third task in the workflow process instance.

Example 2.6. The computer-method of Example 2.5, further comprising: based on the temporal order indicated by the updated arrangement of task elements and the set of relationships between attributes, determining a dependency of an attribute associated with the third task to an attribute associated with the second task.

Example 2.7. The computer-method of any of Examples 2.1-2.6, wherein the method further comprises:
receiving, via the user interface, a definition of a threshold, wherein when the threshold is satisfied during execution of the workflow process instance, the workflow process instance proceeds from the first task to the second task, and wherein when the threshold is not satisfied during execution of the workflow process instance, the workflow process instance proceeds from the first task to a third task.

Example 2.8. The computer-method of any of Examples 2.1-2.7, further comprising verifying that the workflow process instance is valid based on the dependency, wherein the workflow process instance is generated based on the verification.

Example 2.9. The computer-method of any of Examples 2.1-2.8, further comprising:
determining that the workflow process instance is not valid based on the dependency and the temporal order of the first task and the second task;
receiving, via the user interface, an updated arrangement of the task elements, wherein the updated arrangement indicates an updated temporal order of the first task and the second task; and
verifying, based on the dependency and the updated temporal order of the first task and the second task, that the workflow process instance is valid, wherein the workflow process instance is generated based on the verification.

Example 2.10.The computer-method of any of the Examples 2.1-2.9, further comprising: initiating execution of the workflow process instance by communicating the workflow process instance to the client device, causing the client device to execute the executable actions associated with the two or more tasks.

Example 2.11.A system for generating a dynamic identity verification workflow, the system comprising: one or more processors; and one or more computer-readable storage devices storing data instructions that, when executed by the one or more processors, cause the system to: display, via a user interface, task elements of two or more tasks to include in a workflow process instance, wherein each task comprises an executable action to be taken by a client device and a plurality of attributes of the executable action; receive, via the user interface, an arrangement of the task elements, wherein the arrangement indicates a temporal order of a first task and a second task in the workflow process instance; determine a dependency of an attribute associated with the second task to an attribute associated with the first task based on the temporal order and a set of relationships between attributes; and generate the workflow process instance based on the determined dependency.

Example 2.12.A non-transitory computer-readable medium having stored thereon data instructions that, when executed by one or more processors, cause the one or more processors to:
display, via a user interface, task elements of two or more tasks to include in a workflow process instance, wherein each task comprises an executable action to be taken by a client device and a plurality of attributes of the executable action;
receive, via the user interface, an arrangement of the task elements, wherein the arrangement indicates a temporal order of a first task and a second task in the workflow process instance;
determine a dependency of an attribute associated with the second task to an attribute associated with the first task based on the temporal order and a set of relationships between attributes; and
generate the workflow process instance based on the determined dependency.

Examples 2.1-2.12 may provide the technical effect of improving workflow generation by dynamically inferring data and control dependencies between identity-related tasks based on their user-defined temporal ordering and predefined attribute relationships. By automatically determining, validating, and enforcing task dependencies (e.g., including conditional branching and threshold-based progression), the examples reduce configuration errors and allows downstream identity verification, risk, or signing tasks to receive required inputs from prior tasks. As a result, the examples allow for more flexible, correct, and efficient construction and execution of identity verification workflows that can adapt in real time to task reordering and evolving verification requirements.

Example 3.1. A computer-implemented method comprising:
receiving, via an identity verification (IDV) platform, a request to obtain a digital signature from an identity-verified user;
executing a workflow comprising an IDV task and a digital signature capture task by: performing the IDV task to verify the identity of the user, wherein performing the IDV task comprises:
   determining a transaction risk level associated with the request,
   selecting an IDV workflow path from a group consisting of a baseline IDV path and a step-up IDV path based on the risk level associated with the request, wherein the step-up IDV path is selected when the transaction risk level exceeds a configured risk threshold,
   executing the selected IDV process type, and
   generating an IDV result;
determining an identity assurance value based on the transaction risk level, the selected IDV workflow path, and the IDV result;
selecting, based on the identity assurance value, a signature type from a group consisting of a basic electronic signature, an advanced electronic signature (AES), and a qualified electronic signature (QES), wherein a higher risk assessment value results in selection of a signature type providing stronger authentication assurance; and
performing the signature capture task by:
   invoking a signing service integrated with the IDV platform,
   transmitting, to the signing service, a signature request specifying the selected signature type and identifying the user, and
   receiving a signed document from the signing service comprising a digital signature captured according to the selected signature type.

Example 3.2. The computer-implemented method of Example 3.1, wherein the transaction risk level is determined based on one or more of user device characteristics, geolocation data, transaction value, user behavior patterns, or historical fraud indicators.

Example 3.3. The computer-implemented method of Example 3.1 or Example 3.2, wherein the identity assurance value is computed as a weighted combination of the transaction risk level, the selected IDV path, and the identity verification result.

Example 3.4. The computer-implemented method of any of Examples 3.1-3.3, wherein the step-up IDV path comprises at least one of: biometric verification, document authenticity analysis, or liveness detection.

Example 3.5. The computer-implemented method of any of Examples 3.1-3.4, wherein the basic electronic signature is selected when the identity assurance value exceeds a predefined high-confidence threshold.

Example 3.6. The computer-implemented method of any of Examples 3.1-3.5, wherein the qualified electronic signature (QES) is selected when the identity assurance value falls below a predefined low-confidence threshold.

Example 3.7. The computer-implemented method of any of Examples 3.1-3.6, wherein the workflow further comprises an authentication task requiring the user to present a cryptographic credential stored on a user device prior to performing the digital signature capture task.

Example 3.8. The computer-implemented method of Example 3.7, wherein the identity assurance value is further based on the authentication task.

Example 3.9. The computer-implemented method of any of Examples 3.1-3.8, further comprising storing the signed document in association with the identity verification result in a secure document repository.

Example 3.10.The computer-implemented method of any of Examples 3.1-3.9, wherein the workflow is defined using a declarative configuration language and executed by a workflow engine of the IDV platform.

Example 3.11.A system for identity verification and digital signature capture, comprising:
a processor; and
a memory storing instructions that, when executed by the processor, cause the system to:
receive, via an identity verification (IDV) platform, a request to obtain a digital signature from an identity-verified user;
execute a workflow comprising an identity verification task and a digital signature capture task by:
   performing the identity verification task to verify the identity of the user, including: determining a transaction risk level associated with the request;
   selecting an IDV workflow path from a group consisting of a baseline IDV path and a step-up IDV path based on the transaction risk level, wherein the step-up IDV path is selected when the transaction risk level exceeds a configured risk threshold;
   executing the selected IDV workflow path; and
   generating an identity verification (IDV) result; determining an identity assurance value based on the transaction risk level, the selected IDV workflow path, and the IDV result;
selecting, based on the identity assurance value, a signature type from a group consisting of a basic electronic signature, an advanced electronic signature (AES), and a qualified electronic signature (QES), wherein a higher risk assessment value results in selection of a signature type providing stronger authentication assurance; and
performing the digital signature capture task by:
   invoking a signing service integrated with the IDV platform;
   transmitting, to the signing service, a signature request specifying the selected signature type and identifying the user; and
   receiving a signed document from the signing service comprising a digital signature captured according to the selected signature type.

Example 3.12.The system of Example 3.11, wherein the transaction risk level is determined based on one or more of user device characteristics, geolocation data, transaction value, user behavior patterns, or historical fraud indicators.

Example 3.13.The system of Example 3.11 or 3.12, wherein the identity assurance value is computed as a weighted combination of the transaction risk level, the selected IDV workflow path, and the identity verification result.

Example 3.14.The system of any of Examples 3.11-3.13, wherein the step-up IDV workflow path comprises at least one of: biometric verification, document authenticity analysis, or liveness detection.

Example 3.15.The system of any of Examples 3.11-3.14, wherein the basic electronic signature is selected when the identity assurance value exceeds a predefined high-confidence threshold.

Example 3.16.The system of any of Examples 3.11-3.15, wherein the qualified electronic signature (QES) is selected when the identity assurance value falls below a predefined low-confidence threshold.

Example 3.17.The system of any of Examples 3.11-3.16, wherein the workflow further comprises an authentication task requiring the user to present a cryptographic credential stored on a user device prior to performing the digital signature capture task.

Example 3.18.The system of Example 3.17, wherein the identity assurance value is further based on the authentication task.

Example 3.19.The system of any of Examples 3.11-3.18, wherein the memory further stores instructions that, when executed by the processor, cause the system to store the signed document in association with the identity verification result in a secure document repository.

Example 3.20.The system of any of Examples 3.11-3.19, wherein the workflow is defined using a declarative configuration language and executed by a workflow engine of the IDV platform.

Examples 3.1-3.20 may provide the technical effect of dynamically linking identity verification and digital signature capture by adapting both the verification rigor and signature type to a computed transaction-specific risk and identity assurance value. By selecting between baseline and step-up IDV paths and automatically mapping the resulting assurance level to an appropriate signature type (BES, AES, or QES), the examples improve security, regulatory compliance, and user experience without requiring static workflow configuration. As a result, the platform efficiently enforces proportional trust controls, reducing fraud risk and over-authentication while proving receive stronger identity and signature assurance for higher-risk transactions.

1. A computer-implemented method for executing an identity verification workflow, the method comprising:
receiving, at an identity verification workflow platform, a request to obtain a digital signature as part of a workflow, wherein the identity verification platform includes an integrated document signature service configured to capture a first type of electronic signature and a second type of electronic signature; and
executing the workflow, wherein the workflow includes an identity verification task performed by the identity verification workflow platform and a signature capture task performed, at least in part, by the integrated document signature service.

2. The method of claim 1, wherein the integrated document signature service is an external service invoked by the identity verification platform via an application programming interface implemented by the document signature service.

3. The method of claim 1, wherein performing the signature capture task includes:
receiving a document for signature;
transmitting a document signature request including the document to the integrated document signature service; and
receiving, from the integrated document signature service, a signed copy of the document.

4. The method of claim 3, wherein the document signature request includes an indication of a signature type for the document, and wherein the signature type is selected from the first type of electronic signature and the second type of electronic signature based on a compliance rule of the workflow.

5. The method of claim 4, wherein the first type of electronic signature is an advanced electronic signature (AES) and the second type of electronic signature is a qualified electronic signature (QES), and wherein the compliance rule indicates the second type of electronic signature is required.

6. The method of claim 3, wherein the document signature request includes an indication of a signature type for the document, and wherein the signature type is dynamically selected from the first type of electronic signature and the second type of electronic signature based on a verification result of the identity verification.

7. The method of claim 6, wherein the verification result includes a risk assessment value, the first type of electronic signature is an advanced electronic signature (AES), and the second type of electronic signature is a qualified electronic signature (QES), and wherein a higher risk assessment value results in selection of the second type of electronic signature.

8. The method of claim 1, further comprising storing the signed document in association with the identity verification result in a secure document repository.

9. The method of claim 1, wherein the workflow further includes an authentication task requiring a cryptographic credential stored on a user device to be presented to the identity verification platform prior to performing the digital signature capture task.

10. The method of claim 1, wherein the workflow is defined using a declarative configuration language.

11. A system for executing a workflow, the system comprising:
one or more processors; and
one or more computer-readable storage devices storing data instructions that, when executed by the one or more processors, cause the system to:
receive, at an identity verification workflow platform, a request to obtain a digital signature as part of a workflow, wherein the identity verification platform includes an integrated document signature service configured to capture a first type of electronic signature and a second type of electronic signature; and
execute the workflow, wherein the workflow includes an identity verification task performed by the identity verification workflow platform and a signature capture task performed, at least in part, by the integrated document signature service.

12. The system of claim 11, wherein the integrated document signature service is an external service invoked by the identity verification platform via an application programming interface implemented by the document signature service.

13. The system of claim 11, wherein performing the signature capture task includes to:
receive a document for signature;
transmit a document signature request including the document to the integrated document signature service; and
receive, from the integrated document signature service, a signed copy of the document.

14. The system of claim 13, wherein the document signature request includes an indication of a signature type for the document, and wherein the signature type is selected from the first type of electronic signature and the second type of electronic signature based on a compliance rule of the workflow.

15. The system of claim 14, wherein the first type of electronic signature is an advanced electronic signature (AES) and the second type of electronic signature is a qualified electronic signature (QES), and wherein the compliance rule indicates the second type of electronic signature is required.

16. The system of claim 13, wherein the document signature request includes an indication of a signature type for the document, and wherein the signature type for the document is dynamically selected from the first type of electronic signature and the second type of electronic signature based on a verification result of the identity verification.

17. The system of claim 16, wherein the verification result includes a risk assessment value, the first type of electronic signature is an advanced electronic signature (AES), and the second type of electronic signature is a qualified electronic signature (QES), and wherein a higher risk assessment value results in selection of the second type of electronic signature.

18. The system of claim 11, wherein the workflow further includes an authentication task requiring a cryptographic credential stored on a user device to be presented to the identity verification platform prior to performing the digital signature capture task.

19. A non-transitory computer-readable medium having stored thereon data instructions that, when executed by one or more processors, cause the one or more processors to:
receive, at an identity verification workflow platform, a request to obtain a digital signature as part of a workflow, wherein the identity verification platform includes an integrated document signature service configured to capture a first type of electronic signature and a second type of electronic signature; and
execute the workflow, wherein the workflow includes an identity verification task performed by the identity verification workflow platform and a signature capture task performed, at least in part, by the integrated document signature service.

20. The computer-readable medium of claim 19, wherein the integrated document signature service is an external service invoked by the identity verification platform via an application programming interface implemented by the document signature service.
